(19) United States
(12) Patent Application Publication
(10) Pub. No.: US 2003/0158886 A1
(43) Pub. Date: Aug. 21, 2003

(54) System and method for configuring a plurality of computers that collectively render a display

(76) Inventors: Jeffrey J. Walls, Fort Collins, CO (US); Janie Amelia Ledet, Fort Collins, CO (US); Paul Michael Anderson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/974,555

(22) Filed: Oct. 9, 2001

(51) Int. Cl. G06F 15/16

(52) U.S. Cl. 709/201; 709/208

(57) ABSTRACT

The invention relates to a system and method for configuring a plurality of networked slave computers to cooperate to collectively render a display. The method operates by specifying, at a master computer, compatible operating configuration for each of the plurality of slave computers, and communicating, across the network, the specified configuration to each of the plurality of slave computers.

### BACKGROUND OF THE INVENTION

1. Field of the Invention

The present invention generally relates to techniques for rendering graphical displays and, in particular, to a system and method for configuring a plurality of computers that collectively render a display.

2. Related Art

Computer graphical display systems are commonly used for displaying graphical representations of two-dimensional and/or three-dimensional objects on a two-dimensional display device, such as a cathode ray tube, for example. Current computer graphical display systems provide detailed visual representations of objects and are used in a variety of applications.

FIG. 1 depicts an exemplary embodiment of a conventional computer graphical display system 15. A graphics application 17 stored on a computer 21 defines, in data, an object to be rendered by the system 15. To render the object, the application 17 transmits graphical data defining the object to graphics pipeline 23, which may be implemented in hardware, software, or a combination thereof. The graphics pipeline 23, through well-known techniques, processes the graphical data received from the application 17 and stores the graphical data in a frame buffer 26. The frame buffer 26 stores the graphical data necessary to define the image to be displayed by a display device 29. In this regard, the frame buffer 26 includes a set of data for each pixel displayed by the display device 29. Each set of data is correlated with the coordinate values that identify one of the pixels displayed by the display device 29, and each set of data includes the color value of the identified pixel as well as any additional information needed to appropriately color or shade the identified pixel. Normally, the frame buffer 26 transmits the graphical data stored therein to the display device 29 via a scanning process such that each line of pixels defining the image displayed by the display device 29 is consecutively updated.

When large images are to be displayed, multiple display devices may be used to display a single image, in which each display device displays a portion of the single image. In such an embodiment, the multiple display devices are treated as a single logical screen (SLS), and different portions of an object may be rendered by different display devices. FIG. 2 depicts an exemplary embodiment of a computer graphics system 41 capable of utilizing a plurality of display devices 31-34 to render a single logical screen. In this embodiment, a client computer 42 stores the application 17 that defines, in data, an image to be displayed. Each of the display devices 31-34 may be used to display a portion of an object such that the display devices 31-34, as a group, display a single large image of the object.

To render the object, graphical data defining the object is transmitted to an SLS server 45. The SLS server 45 routes the graphical data to each of the graphics pipelines 36-39 for processing and rendering. For example, assume that the object is to be positioned such that each of the display devices 31-34 displays a portion of the object. Each of the pipelines 36-39 renders the graphical data into a form that can be written into one of the frame buffers 46-49. Once the data has been rendered by the pipelines 36-39 to the point that the graphical data is in a form suitable for storage into frame buffers 46-49, each of the pipelines 36-39 performs a clipping process before transmitting the data to frame buffers 46-49.

In the clipping process, each pipeline 36-39 discards the graphical data defining the portions of the object that are not to be displayed by the pipeline's associated display device 31-34 (i.e., the display device 31-34 coupled to the pipeline 36-39 through one of the frame buffers 4649). In other words, each graphics pipeline 36-39 discards the graphical data defining the portions of the object displayed by the display devices 31-34 that are not coupled to the pipeline 36-39 through one of the frame buffers 46-49. For example, pipeline 36 discards the graphical data defining the portions of the object that are displayed by display devices 32-34, and pipeline 37 discards the graphical data defining the portions of the object that are displayed by display devices 31, 33, and 34.

Thus, each frame buffer 46-49 should only store the graphical data defining the portion of the object displayed by the display device 31-34 that is coupled to the frame buffer 46-49. At least one solution for providing SLS functionality in an X Window System environment is taught by Jeffrey J. Walls, Ian A. Elliott, and John Marks in U.S. Pat. No. 6,088,005, filed Jan. 10, 1996, and entitled “Design and Method for a Large, Virtual Workspace,” which is incorporated herein by reference.

A plurality of networked computer systems is often employed in implementing SLS technology. For example, in the embodiment shown by FIG. 2, the client 42, the SLS server 45, and the individual graphics pipelines 36-39 may each be implemented via a single computer system interconnected with the other computer systems within the system 41 via a computer network, such a local area network (LAN), for example. The X Window System is a standard for implementing window-based user interfaces in a networked computer environment, and it may be desirable to utilize X Protocol in rendering graphical data in the system 41. For a more detailed discussion of the X Window System and the X Protocol that defines it, see Adrian Nye, X Protocol Reference Manual Volume Zero (O' Riley & Associates 1990).

U.S. patent application Ser. No. 09/138,456, filed on Aug. 21, 1998, and entitled “3D Graphics in a Single Logical Screen Display Using Multiple Remote Computer Systems,” which is incorporated herein by reference, describes an SLS system of networked computer stations that may be used to render two-dimensional (2D) and three-dimensional (3D) graphical data. In the embodiments described by the foregoing patent application, X Protocol is generally utilized to render 2D graphical data, and OpenGL Protocol (OGL) is generally used to render 3D graphical data.

Although it is possible to render 2D and/or 3D data in conventional computer graphical display systems, including SLS environments, there exists limitations that restrict the performance and/or image quality exhibited by the conventional computer graphical display systems. More specifically, high quality images, particularly 3D images, are typically defined by a large amount of graphical data, and the speed at which conventional graphics pipelines 36-39 can process the graphical data defining an object is limited. Thus, a trade-off often exists between increasing the quality of the image rendered by a computer graphical display system and the speed at which the image can be rendered.

### SUMMARY OF THE INVENTION

Briefly described, the present invention relates to a system and method for configuring a plurality of networked slave computers to cooperate to collectively render a display. An embodiment of the method operates by specifying, at a master computer, compatible operating configuration for each of the plurality of computers, and communicating, across the network, the specified configuration to each of the plurality of slave computers.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a conventional graphical display system.

FIG. 2 is a block diagram illustrating a conventional single logical screen (SLS) graphical display system.

FIG. 3 is a block diagram illustrating a graphical display system in accordance with the present invention.

FIG. 4 is a block diagram illustrating a more detailed view of a client depicted in FIG. 3.

FIG. 5 is a block diagram illustrating a more detailed view of a master pipeline depicted in FIG. 3.

FIG. 6 is a block diagram illustrating a more detailed view of a slave pipeline depicted in FIG. 3.

FIG. 7 is a diagram illustrating a more detailed view of a display device depicted in FIG. 3. The display device of FIG. 7 is displaying an exemplary X window having a center region for displaying three-dimensional objects.

FIG. 8 is a diagram illustrating the display device depicted in FIG. 7 with the center region partitioned according to one embodiment of the present invention.

FIG. 9 is a diagram illustrating the display device depicted in FIG. 7 with the center region partitioned according to another embodiment of the present invention.

FIG. 10 is a diagram illustrating the display device depicted in FIG. 8 with a three-dimensional object displayed within the center region.

FIG. 11 is a diagram illustrating the display device depicted in FIG. 7 when super sampled data residing in one of the frame buffers interfaced with one of the slave pipelines is displayed within the center region of the display device.

FIG. 12 is a diagram illustrating the display device depicted in FIG. 11 when super sampled data residing in another of the frame buffers interfaced with another of the slave pipelines is displayed within the center region of the display device.

FIG. 13 is a block diagram illustrating another embodiment of the graphical display system depicted in FIG. 3.

FIG. 14 is a single logical screen (SLS) graphical display system that utilizes a graphical acceleration unit depicted in FIG. 3 or FIG. 13.

FIG. 15 is a diagram illustrating a more detailed view of display devices that are depicted in FIG. 14.

FIG. 16 is a diagram illustrating certain principal components of the system 300 constructed in accordance with one embodiment of the invention.

FIG. 17 is a diagram illustrating certain principal components of a system constructed in accordance with an alternative embodiment of the present invention.

FIG. 18 is a diagram that illustrates certain hardware components of the system of FIGS. 16 and 17 in more detail;

FIG. 19 is a flowchart illustrating the top-level operation of a system constructed in accordance with the invention;

FIG. 20 is a flowchart illustrating the top-level operation of the “Read Configuration File” step illustrated in FIG. 19.

FIG. 21 is a flowchart illustrating the top-level operation of the “Configure Graphics Node Devices” step illustrated in FIG. 19.

FIG. 22 is a flowchart illustrating the top-level operation of the “Configure Graphics Node Configuration Files” step illustrated in FIG. 19.

FIG. 23 is a diagram illustrating example configuration files and screens.

FIG. 24 is a diagram illustrating example configuration files and screens.

FIG. 25 is a diagram illustrating certain slave configurations.

FIG. 26 is a diagram illustrating a system configuration for a 1×3 display.

FIG. 27 is a diagram illustrating a system configuration for a 2×2 display.

FIG. 28 is a diagram illustrating a three-tiered system configuration.

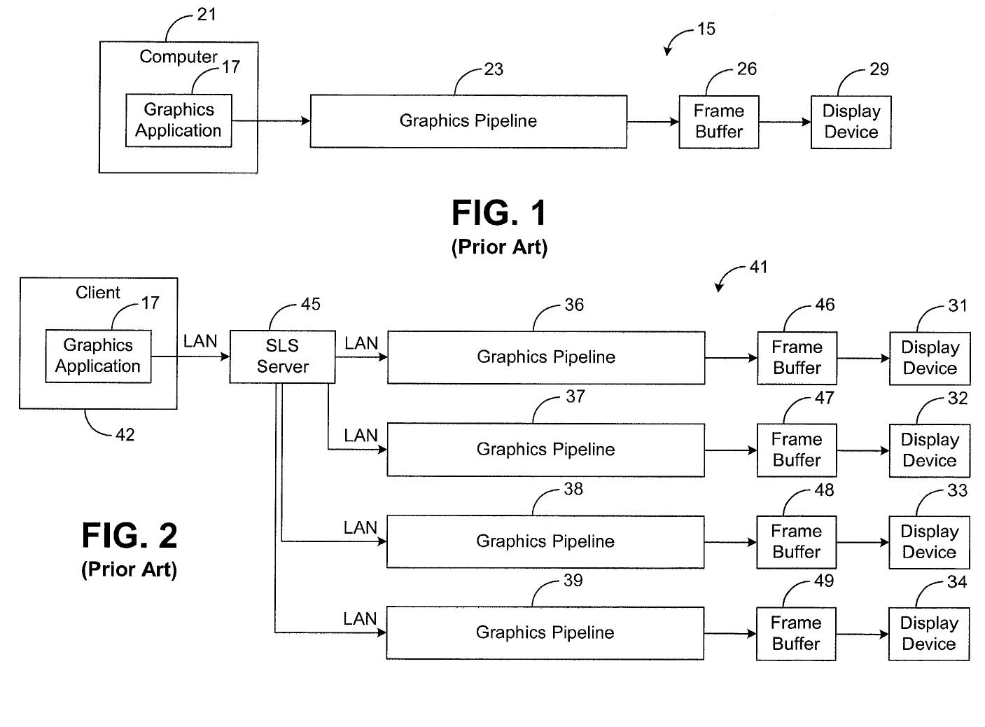

### DETAILED DESCRIPTION OF THE PREFERRED EMBODIMENT

In general, the present invention is broadly directed to a system for effectively and efficiently configuring a plurality of computers to cooperate to collectively render a single graphic display, where each computer processes and renders the graphics of a portion of the display. It has been found that, in systems of this type, configuring the various computers can be a cumbersome and problematic process. Each such computer is generally equipped with a graphics card that contains the hardware and other processing logic for processing and rendering graphics to a display, and such graphics cards are typically designed to be highly configurable. Depending upon the particular configuration of the graphics cards among the various computers, the graphics cards may be in any of a number of operating states. For a plurality of computers to cooperatively render a single display, it is important that their respective graphics cards be operating in compatible states. For example, if a graphics card on a first computer is configured to run in “stereo” mode while a graphics card on a second computer is configured to run in “mono” mode, the two graphics cards would not be able to cooperate properly to render a display. Therefore, it is important that all such graphics cards be configured to operate in compatible (although not necessarily identical) states or modes.

One way of configuring such compatible operation is to separately and independently configure each individual computer's graphics card. The manner in which graphics cards are initialized and configured is known by persons skilled in the art, and need not be described herein. As is known, however, at a higher level certain configuration options or commands may be specified through a configuration file that is stored under a known name an in a known location. These options or commands can specify the operating conditions of the display, such as the display resolution, mode, etc. Again, the specific manner in which such configuration files are processed to initialize and configure a graphics card is known and need not be described herein.

Therefore, it is important that the various configuration files (or other mechanism utilized to configure the individual graphics cards) are consistently or compatibly scripted. If even a single graphics card in such a system is incompatibly configured with the graphics cards of the remainder of the computers, then the collection of computers may not be able to render the display. It should be appreciated that, as the number of cooperating computers increases, the probability of error in consistently configuring all of the computers increases. In addition, to the extent that each of the computers is redundantly configured, as the number of computers increases, the amount of duplicative configuration effort increases.

The present invention addresses this these shortcomings by providing an effective and efficient system and method for consistently configuring a plurality of computers to cooperate to render a graphics display. As will be discussed in more detail below, the preferred inventive system and method operates by translating graphics configuration information that may be provided in a single configuration file into configuration information suitable for communication to a plurality of computers that cooperated to render a single display. This information may be separately communicated to the various computers in the plurality of computers by way of separate files (stored in predetermined locations) or by way of direct communication through a communication port or socket.

Illustrative Environment of the Present Invention

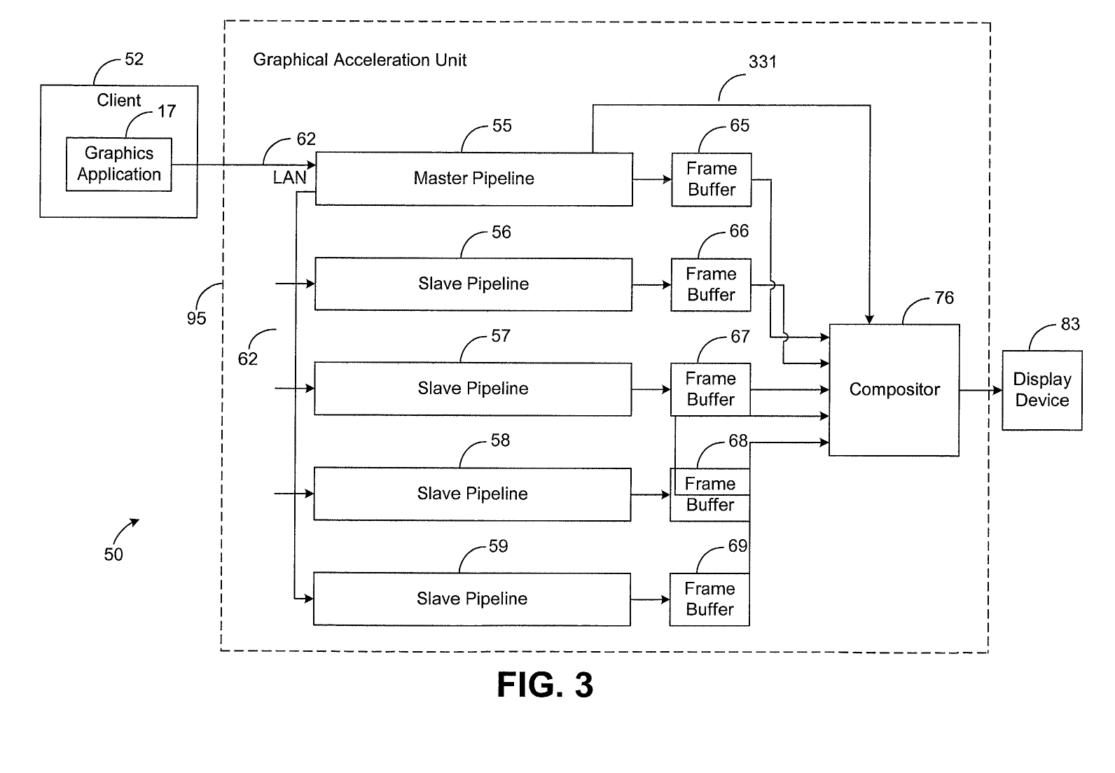

Before describing the preferred embodiment of the present invention, an illustrative environment will first be described. In this regard, the present invention may be used to configure a multi-processor/multi-pipeline graphics system for rendering graphics on a single graphics display. FIG. 3 depicts a computer graphical display system 50 in accordance with such a preferred environment. As shown by FIG. 3, the system 50 includes a client 52, a master graphics pipeline 55, and one or more slave graphics pipelines 56-59. The client 52 and pipelines 55-59 may be implemented via hardware, software or any combination thereof. It should be noted that the embodiment shown by FIG. 3 depicts four slave pipelines 56-59 for illustrative purposes only, and any number of slave pipelines 56-59 may be employed to implement the system in other embodiments. As shown by FIG. 3, the pipelines 55-59, frame buffers 65-69, and compositor 76 that render graphical data to a single display device 83 are collectively referred to herein as a graphical accelerations unit 95.

The master pipeline 55 receives graphical data from the application 17 stored in the client 52. The master pipeline 55 preferably renders two-dimensional (2D) graphical data to frame buffer 65 and routes three-dimensional (3D) graphical data to slave pipelines 56-59, which render the 3D graphical data to frame buffers 66-69, respectively. Except as otherwise described herein, the client 52 and the pipelines 55-59 may be configured similar to pipelines described in U.S. patent application Ser. No. 09/138,456. The client 52 and the pipelines 55-59 will be described in more detail hereinafter.

Each frame buffer 65-69 outputs a stream of graphical data to the compositor 76. The compositor 76 is configured to combine or composite each of the data streams from frame buffers 65-69 into a single data stream that is provided to display device 83, which may be a monitor (e.g., cathode ray tube) or other device for displaying an image. The graphical data provided to the display device 83 by the compositor 76 defines the image to be displayed by the display device 83 and is based on the graphical data received from frame buffers 65-69. The compositor 76 will be further described in more detail hereinafter. Note that each data stream depicted in FIG. 3 may be either a serial data stream or a parallel data stream.

In the preferred embodiment, the client 52 and each of the pipelines 55-59 are respectively implemented via stand alone computer systems, commonly referred to as a “computer workstations.” Thus, the system 50 shown by FIG. 3 may be implemented via six computer workstations (i.e., one computer workstation for the client 52 and one computer workstation for each of the pipelines 55-59). However, it is possible to implement the client 52 and pipelines 55-59 via other configurations, including other numbers of computer workstations or no computer workstations. As an example, the client 52 and the master pipeline 55 may be implemented via a single computer workstation. Any computer workstation used to implement the client 52 and/or pipelines 55-59 may be utilized to perform other desired functionality when the workstation is not being used to render graphical data.

Furthermore, as shown by FIG. 3, the client 52 and the pipelines 55-59 may be interconnected via a local area network (LAN) 62. However, it is possible to utilize other types of interconnection circuitry without departing from the principles of the illustrated system.

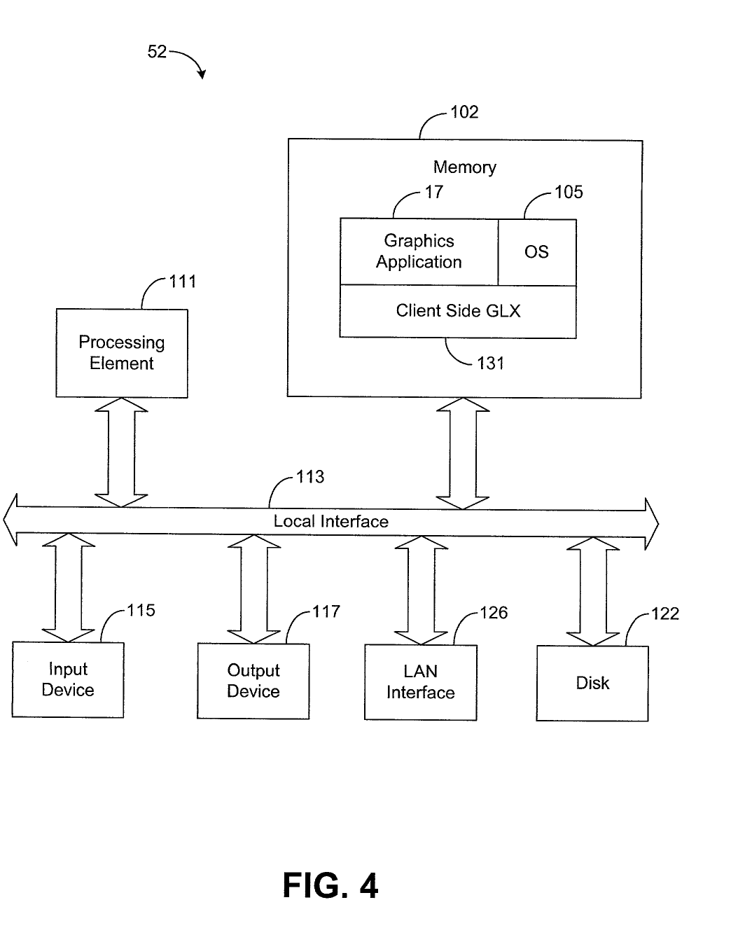

FIG. 4 depicts a more detailed view of the client 52. As can be seen by referring to FIG. 4, the client 52 preferably stores the graphics application 17 in memory 102. Through conventional techniques, the application 17 is executed by an operating system 105 and one or more conventional processing elements 111, such as a central processing unit (CPU), for example. The operating system 105 performs functionality similar to conventional operating systems. More specifically, the operating system 105 controls the resources of the client 52 through conventional techniques and interfaces the instructions of the application 17 with the processing element 111 as necessary to enable the application 17 to run properly.

The processing element 111 communicates to and drives the other elements within the client 52 via a local interface 113, which can include one or more buses. Furthermore, an input device 115, for example, a keyboard or a mouse, can be used to input data from a user of the client 52, and an output device 117, for example, a display device or a printer, can be used to output data to the user. A disk storage mechanism 122 can be connected to the local interface 113 to transfer data to and from a nonvolatile disk (e.g., magnetic, optical, etc.). The client 52 is preferably connected to a LAN interface 126 that allows the client 52 to exchange data with the LAN 62.

In the preferred embodiment, X Protocol is generally utilized to render 2D graphical data, and OpenGL Protocol (OGL) is generally utilized to render 3D graphical data, although other types of protocols may be utilized in other embodiments. By way of background, OpenGL Protocol is a standard application programmer's interface (API) to hardware that accelerates 3D graphics operations. Although OpenGL Protocol is designed to be window system independent, it is often used with window systems, such as the X Window System, for example. In order that OpenGL Protocol may be used in an X Window System environment, an extension of the X Window System has been developed called GLX. For more complete information on the GLX extension to the X Window System and on how OpenGL Protocol can be integrated with the X Window System, see for example Mark J. Kilgard, OpenGL Programming for the X Window System (Addison-Wesley Developers Press 1996), which is incorporated herein by reference.

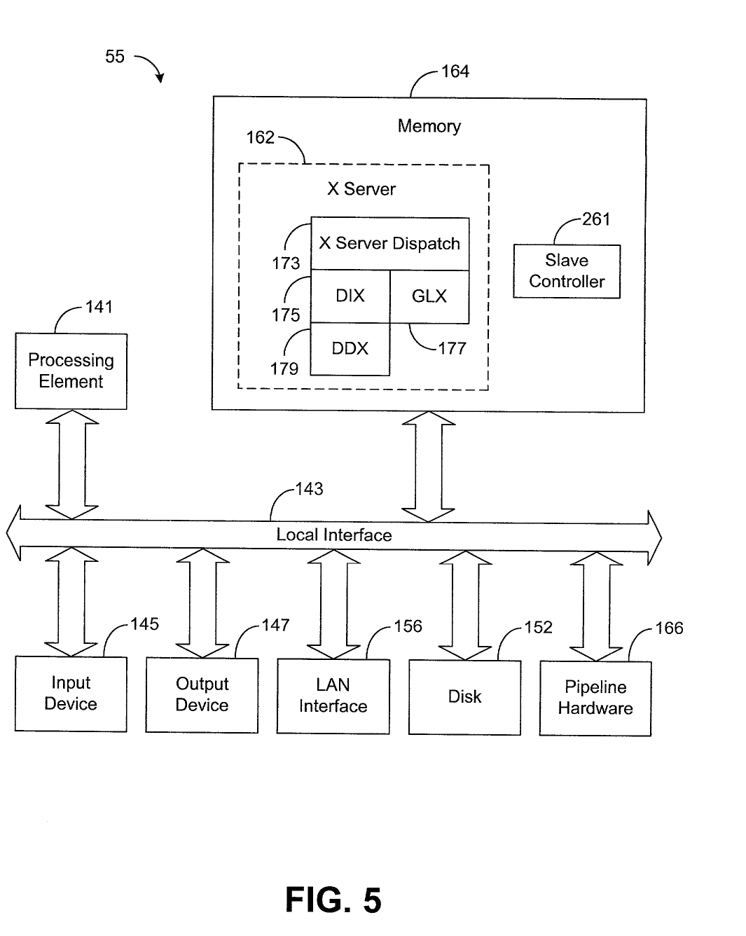

When the application 17 issues a graphical command, a client side GLX layer 131 of the client 52 transmits the command over LAN 62 to master pipeline 55. FIG. 5 depicts a more detailed view of the master pipeline 55. Similar to client 52, the master pipeline 55 includes one or more processing elements 141 that communicate to and drive the other elements within the master pipeline 55 via a local interface 143, which can include one or more buses. Furthermore, an input device 145, for example, a keyboard or a mouse, can be used to input data from a user of the pipeline 55, and an output device 147, for example, a display device or a printer, can be used to output data to the user. A disk storage mechanism 152 can be connected to the local interface 143 to transfer data to and from a nonvolatile disk (e.g., magnetic, optical, etc.). The pipeline 55 may be connected to a LAN interface 156 that allows the pipeline 55 to exchange data with the LAN 62.

The pipeline 55 also includes an X server 162. The X server 162 may be implemented in software, hardware, or a combination thereof, and in the embodiment shown by FIG. 5, the X server 162 is implemented in software and stored in memory 164. In the preferred embodiment, the X server 162 renders 2D X window commands, such as commands to create or move an X window. In this regard, an X server dispatch layer 173 is designed to route received commands to a device independent layer (DIX) 175 or to a GLX layer 177. An X window command that does not include 3D data is interfaced with DIX, whereas an X window command that does include 3D data (e.g., an X command having embedded OGL protocol, such as a command to create or change the state of a 3D image within an X window) is routed to GLX layer 177. A command interfaced with the DIX 175 is executed by the DIX 175 and potentially by a device dependent layer (DDX) 179, which drives graphical data associated with the executed command through pipeline hardware 166 to frame buffer 65. A command interfaced with GLX layer 177 is transmitted by the GLX layer 177 across LAN 62 to slave pipelines 56-59. One or more of the pipelines 56-59 executes the command and drives graphical data associated with the command to one or more frame buffers 66-69.

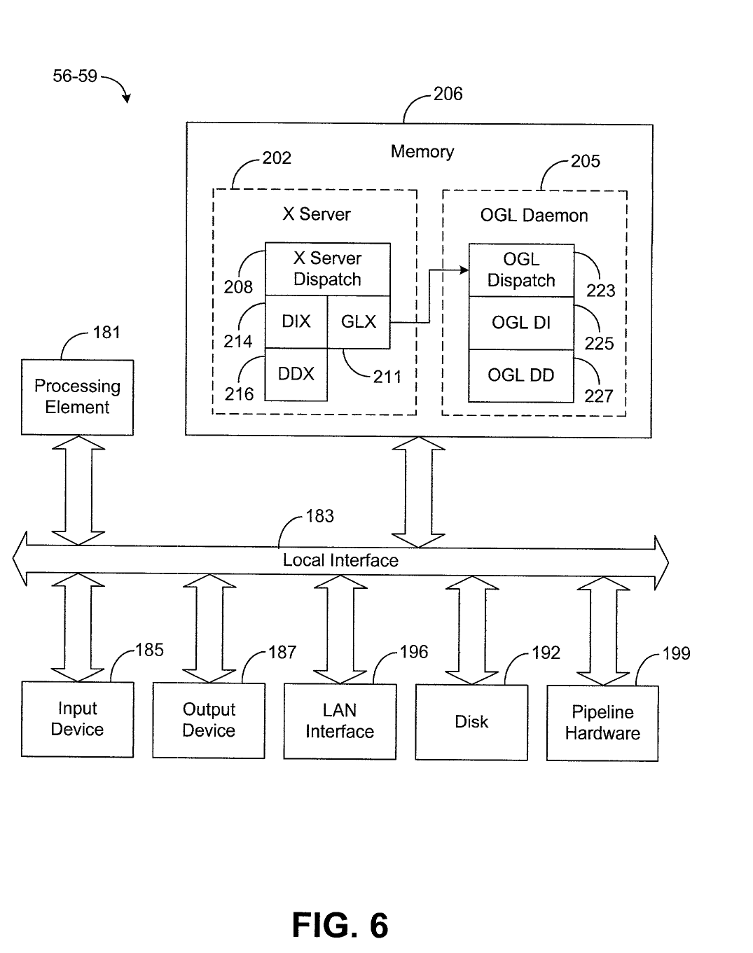

In the preferred embodiment, each of slave pipelines 56-59 is configured according to FIG. 6, although other configurations of pipelines 56-59 in other embodiments are possible. As shown by FIG. 6, each slave pipeline 56-59 includes an X server 202, similar to the X server 162 previously described, and an OGL daemon 205. The X server 202 and OGL daemon 205 may be implemented in software, hardware, or a combination thereof, and in the embodiment shown by FIG. 6, the X server 202 and OGL daemon 205 are implemented in software and stored in memory 206. Similar to client 52 and master pipeline 55, each of the slave pipelines 56-59 includes one or more processing elements 181 that communicate to and drive the other elements within the pipeline 56-59 via a local interface 183, which can include one or more buses. Furthermore, an input device 185, for example, a keyboard or a mouse, can be used to input data from a user of the pipeline 56-59, and an output device 187, for example, a display device or a printer, can be used to output data to the user. A disk storage mechanism 192 can be connected to the local interface 183 to transfer data to and from a nonvolatile disk (e.g., magnetic, optical, etc.). Each pipeline 56-59 is preferably connected to a LAN interface 196 that allows the pipeline 56-59 to exchange data with the LAN 62.

Similar to X server 162, the X server 202 includes an X server dispatch layer 208, a GLX layer 211, a DIX layer 214, and a DDX layer 216. In the preferred embodiment, each command received by the slave pipelines 56-59 includes 3D graphical data, since the X server 162 of master pipeline 55 executes each X window command that does not include 3D graphical data. The X server dispatch layer 208 interfaces the 2D data of any received commands with DIX layer 214 and interfaces the 3D data of any received commands with GLX layer 211. The DIX and DDX layers 214 and 216 are configured to process or accelerate the 2D data and to drive the 2D data through pipeline hardware 166 to one of the frame buffers 66-69 (FIG. 3).

The GLX layer 211 interfaces the 3D data with the OGL dispatch layer 223 of the OGL daemon 205. The OGL dispatch layer 223 interfaces this data with the OGL DI layer 225. The OGL DI layer 225 and DD layer 227 are configured to process the 3D data and to accelerate or drive the 3D data through pipeline hardware 199 to one of the frame buffers 66-69 (FIG. 3). Thus, the 2D graphical data of a received command is processed or accelerated by the X server 202, and the 3D graphical data of the received command is processed or accelerated by the OGL daemon 205. For a more detailed description of the foregoing process of accelerating 2D data via an X server 202 and of accelerating 3D data via an OGL daemon 205, refer to U.S. patent application Ser. No. 09/138,456.

Preferably, the slave pipelines 56-59, based on inputs from the master pipeline 55, are configured to render 3D images based on the graphical data from master pipeline 55 according to one of three modes of operation: the optimization mode, the super-sampling mode, and the jitter mode. In the optimization mode, each of the slave pipelines 56-59 renders a different portion of a 3D image such that the overall process of rendering the 3D image is faster. In the super-sampling mode, each portion of a 3D image rendered by one or more of the slave pipelines 56-59 is super-sampled in order to increase quality of the 3D image via anti-aliasing. Furthermore, in the jitter mode, each of the slave pipelines 56-59 renders the same 3D image but slightly offsets each rendered 3D image with a different offset value. Then, the compositor 76 averages the pixel data of each pixel for the 3D images rendered by the pipelines 56-59 in order to produce a single 3D image of increased image quality. Each of the foregoing modes will be described in more detail hereafter.

Optimization Mode

Referring to FIG. 3, the operation and interaction of the client 52, the pipelines 55-59, and the compositor 76 will now be described in more detail according to a preferred embodiment of the illustrated environment while the system 50 is operating in the optimization mode. In such an embodiment, the master pipeline 55, in addition to controlling the operation of the slave pipelines 56-59 as described hereinafter, is used to create and manipulate an X window to be displayed by the display device 83. Furthermore, each of the slave pipelines 56-59 is used to render 3D graphical data within a portion of the foregoing X window.

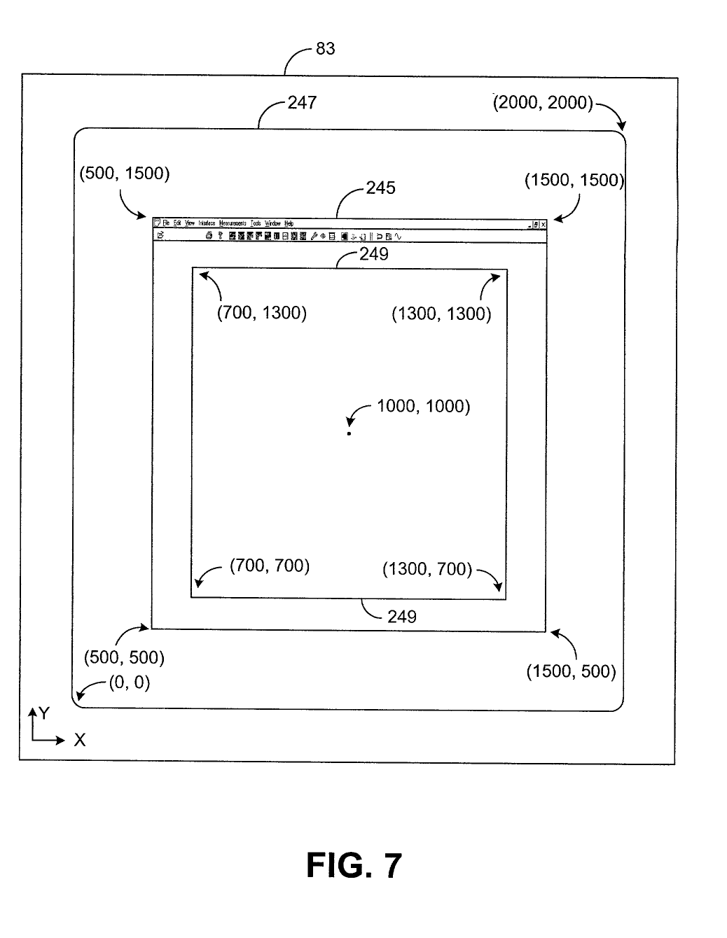

For the purposes of illustrating the aforementioned embodiment, assume that the application 17 issues a function call (i.e., the client 52 via processing element 111 (FIG. 4) executes a function call within the application 17) for creating an X window having a 3D image displayed within the X window. FIG. 7 depicts a more detailed view of the display device 83 displaying such a window 245 on a display device screen 247. In the example shown by FIG. 7, the screen 247 is 2000 pixels by 2000 pixels (“2K×2K”), and the X window 245 is 1000 pixels by 1000 pixels (“1K×1K”). The window 245 is offset from each edge of the screen 247 by 500 pixels. Assume that 3D graphical data is to be rendered in a center region 249 of the X window 245. This center region 249 is offset from each edge of the window 245 by 200 pixels in the embodiment shown by FIG. 7.

In response to execution of the function call by client 52, the application 17 transmits to the master pipeline 55 a command to render the X window 245 and a command to render a 3D image within portion 249 of the X window 245. The command for rendering the X window 245 should include 2D graphical data defining the X window 245, and the command for rendering the 3D image within the X window 245 should include 3D graphical data defining the 3D image to be displayed within region 249. Preferably, the master pipeline 55 renders 2D graphical data from the former command (i.e., the command for rendering the X window 245) to frame buffer 65 (FIG. 3) via X server 162 (FIG. 6).

The graphical data rendered by any of the pipelines 55-59 includes sets of values that respectively define a plurality of pixels. Each set of values includes at least a color value and a plurality of coordinate values associated with the pixel being defined by the set of values. The coordinate values define the pixel's position relative to the other pixels defined by the graphical data, and the color value indicates how the pixel should be colored. While the coordinate values indicate the pixel's position relative to the other pixels defined by the graphical data, the coordinate values produced by the application 17 are not the same coordinate values assigned by the display device 83 to each pixel of the screen 247. Thus, the pipelines 55-59 should translate the coordinate values of each pixel rendered by the pipelines 55-59 to the coordinate values used by the display device 83 to display images. Sometimes the coordinate values produced by the application 17 are said to be “window relative,” and the aforementioned coordinate values translated from the window relative coordinates are said to be “screen relative.” The concept of translating window relative coordinates to screen relative coordinates is well known, and techniques for translating window relative coordinates to screen relative coordinates are employed by most conventional graphical display systems.

In addition to translating coordinates of the 2D data rendered by the master pipeline 55 from window relative to screen relative, the master pipeline 55 in each mode of operation also assigns a particular color value, referred to hereafter as the “chroma-key,” to each pixel within the region 249. The chroma-key indicates which pixels within the X window 245 may be assigned a color value of a 3D image that is generated by slave pipelines 56-59. In this regard, each pixel assigned the chroma-key as the color value by master server 55 is within region 249 and, therefore, may be assigned a color of a 3D object rendered by slave pipelines 56-59, as will be described in further detail hereafter. In the example shown by FIG. 7, the graphical data rendered by master pipeline 55 and associated with screen relative coordinate values ranging from (700, 700) to (1300, 1300) are assigned the chroma-key as their color value by the master pipeline 55, since the region 249 is the portion of X window 245 that is to be used for displaying 3D images.

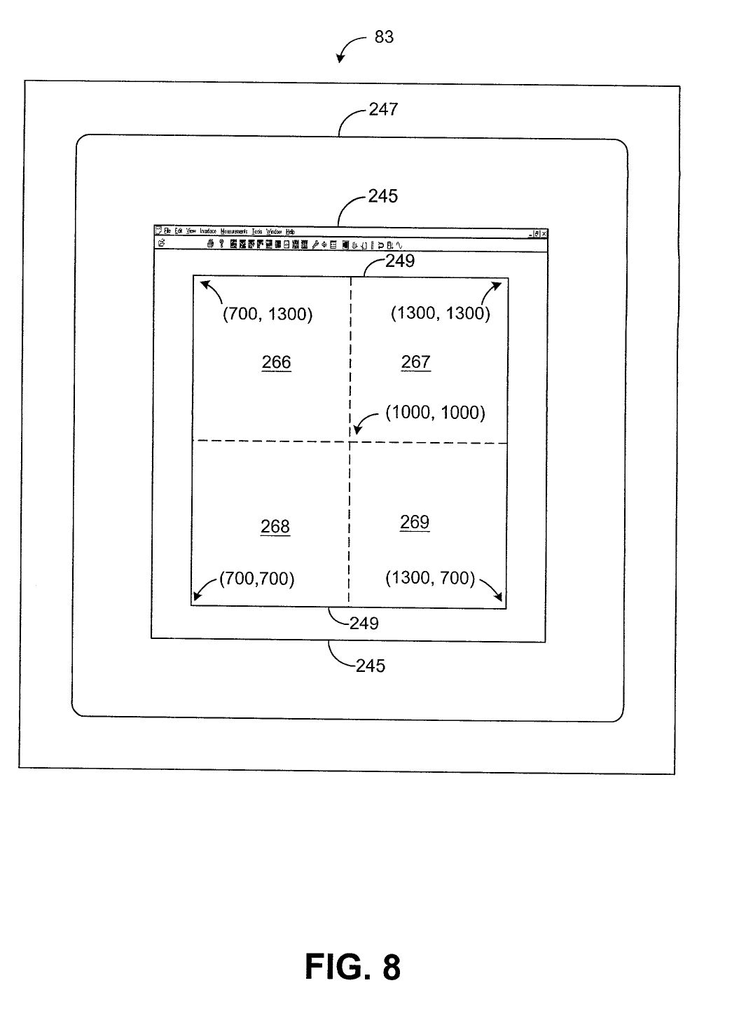

As shown by FIG. 5, the master pipeline 55 includes a slave controller 261 that is configured to provide inputs to each slave pipeline 56-59 over the LAN 62. The slave controller 261 may be implemented in software, hardware, or a combination thereof, and in the embodiment shown by FIG. 5, the slave controller 261 is implemented in software and stored in memory 206. The inputs from the slave controller 261 inform the slaves 56-59 of which mode each slave 56-59 should presently operate. In the present example, the slave controller 261 transmits inputs to each slave 56-59 indicating that each slave 56-59 should be in the optimization mode of operation. The inputs from slave controller 261 also indicate which portion of region 249 (FIG. 7) that is each slave's responsibility. For example, assume for illustrative purposes, that each slave 56-59 is responsible for rendering the graphical data displayed in one of the portions 266-269 shown by FIG. 8.

In this regard, assume that: (1) slave pipeline 56 is responsible for rendering graphical data defining the image displayed in portion 266 (i.e., screen relative coordinates (700, 1000) to (1000, 1300), (2) slave pipeline 57 is responsible for rendering graphical data defining the image displayed in portion 267 (i.e., screen relative coordinates (1000, 1000) to (1300, 1300), (3) slave pipeline 58 is responsible for rendering graphical data defining the image displayed in portion 268 (i.e., screen relative coordinates (700, 700) to (1000, 1000), and (4) slave pipeline 59 is responsible for rendering graphical data defining the image displayed in portion 269 (i.e., screen relative coordinates (1000, 700) to (1300, 1000). The inputs transmitted by the slave controller 261 to the slave pipelines 56-59 preferably indicate the range of screen coordinate values that each slave pipeline 56-59 is responsible for rendering.

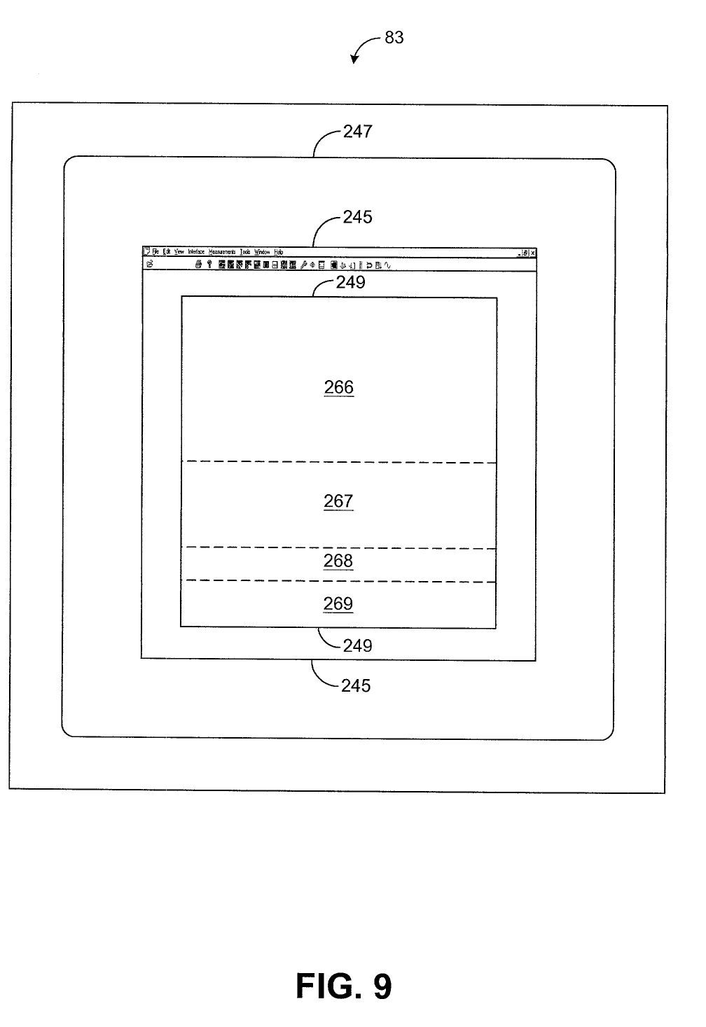

Note that the partition of the region 249 can be divided among the pipelines 56-59 via other configurations, and it is not necessary for each pipeline 56-59 to be responsible for an equally sized area of the region 249. For example, FIG. 9 shows an embodiment where each portion 266-269 represents a different sized horizontal area of the region 249.

Each slave pipeline 56-59 is configured to receive from master pipeline 55 the graphical data of the command for rendering the 3D image to be displayed in region 249 and to render this data to frame buffers 66-69, respectively. In this regard, each pipeline 56-59 renders graphical data defining a 2D X window that displays a 3D image within the window. More specifically, slave pipeline 56 renders graphical data to frame buffer 66 that defines an X window displaying a 3D image within portion 266 (FIG. 8). The X server 202 within slave pipeline 56 renders the data that defines the foregoing X window, and the OGL daemon 205 within the slave pipeline 56 renders the data that defines the 3D image displayed within the foregoing X window. Furthermore, slave pipeline 57 renders graphical data to frame buffer 67 that defines an X window displaying a 3D image within portion 267 (FIG. 8). The X server 202 within slave pipeline 57 renders the data that defines the foregoing X window, and the OGL daemon 205 within the slave pipeline 57 renders the data that defines the 3D image displayed within the foregoing X window. Similarly, slave pipelines 58 and 59 render graphical data to frame buffers 68 and 69, respectively, via the X server 202 and the OGL daemon 205 within the pipelines 58 and 59.

Note that the graphical data rendered by each pipeline 56-59 defines a portion of the overall image to be displayed within region 249. Thus, it is not necessary for each pipeline 56-59 to render all of the graphical data defining the entire 3D image to be displayed in region 249. Indeed, in the preferred embodiment, each slave pipeline 56-59 preferably discards the graphical data that defines a portion of the image that is outside of the pipeline's responsibility. In this regard, each pipeline 56-59 receives from master pipeline 55 the graphical data that defines the 3D image to be displayed in region 249. Each pipeline 56-59, based on the aforementioned inputs received from slave controller 261 then determines which portion of this graphical data is within pipeline's responsibility and discards the graphical data outside of this portion.

For example, as described previously, slave pipeline 56 is responsible for rendering the graphical data defining the image to be displayed within portion 266 of FIG. 8. This portion 266 includes graphical data associated with screen relative coordinates (700, 1000) to (1000, 1300). Thus, any graphical data having screen relative coordinates outside of this range is discarded by the pipeline 56, and only graphical data having screen relative coordinates within the foregoing range is rendered to frame buffer 66.

Furthermore, slave pipeline 57 is responsible for rendering the graphical data defining the image to be displayed within portion 267 of FIG. 8. This portion 267 includes graphical data associated with screen relative coordinates (1000, 1000) to (1300, 1300). Thus, any graphical data having screen relative coordinates outside of this range is discarded by the pipeline 57, and only graphical data having screen relative coordinates within the foregoing range is rendered to frame buffer 67.

In addition, slave pipeline 58 is responsible for rendering the graphical data defining the image to be displayed within portion 268 of FIG. 8. This portion 268 includes graphical data associated with screen relative coordinates (700, 700) to (1000, 1000). Thus, any graphical data having screen relative coordinates outside of this range is discarded by the pipeline 58, and only graphical data having screen relative coordinates within the foregoing range is rendered to frame buffer 68.

Also, slave pipeline 59 is responsible for rendering the graphical data defining the image to be displayed within portion 269 of FIG. 8. This portion 269 includes graphical data associated with screen relative coordinates (1000, 700) to (1300, 1000). Thus, any graphical data having screen relative coordinates outside of this range is discarded by the pipeline 59, and only graphical data having screen relative coordinates within the foregoing range is rendered to frame buffer 69.

To increase the efficiency of the system 50, each slave pipeline 56-59 preferably discards the graphical data outside of the pipeline's responsibility before significantly processing any of the data to be discarded. Bounding box techniques may be employed to enable each pipeline 56-59 to quickly discard a large amount of graphical data outside of the pipeline's responsibility before significantly processing such graphical data.

In this regard, each set of graphical data transmitted to pipelines 56-59 may be associated with a particular set of bounding box data. The bounding box data defines a graphical bounding box that contains at least each pixel included in the graphical data that is associated with the bounding box data. The bounding box data can be quickly processed and analyzed to determine whether a pipeline 56-59 is responsible for rendering any of the pixels included within the bounding box. If the pipeline 56-59 is responsible for rendering any of the pixels included within the bounding box, then the pipeline 56-59 renders the received graphical data that is associated with the bounding box. However, if the pipeline 56-59 is not responsible for rendering any of the pixels included within the bounding box, then the pipeline 56-59 discards the received graphical data that is associated with the bounding box, and the pipeline 56-59 does not attempt to render the discarded graphical data. Thus, processing power is not wasted in rendering any graphical data that defines an object outside of the pipeline's responsibility and that can be discarded via the utilization of bounding box techniques as described above. Bounding box techniques are more fully described in U.S. Pat. No. 5,757,321, entitled “Apparatus and Method for Clipping Primitives Using Information from a Previous Bounding Box Process,” which is incorporated herein by reference.

After the pipelines 56-59 have respectively rendered graphical data to frame buffers 65-69, the graphical data is read out of frame buffers 65-69 through conventional techniques and transmitted to compositor 76. Through techniques described in more detail hereafter, the compositor 76 is designed to composite or combine the data streams from frame buffers 65-69 into a single data stream and to render the data from this single data stream to display device 83.

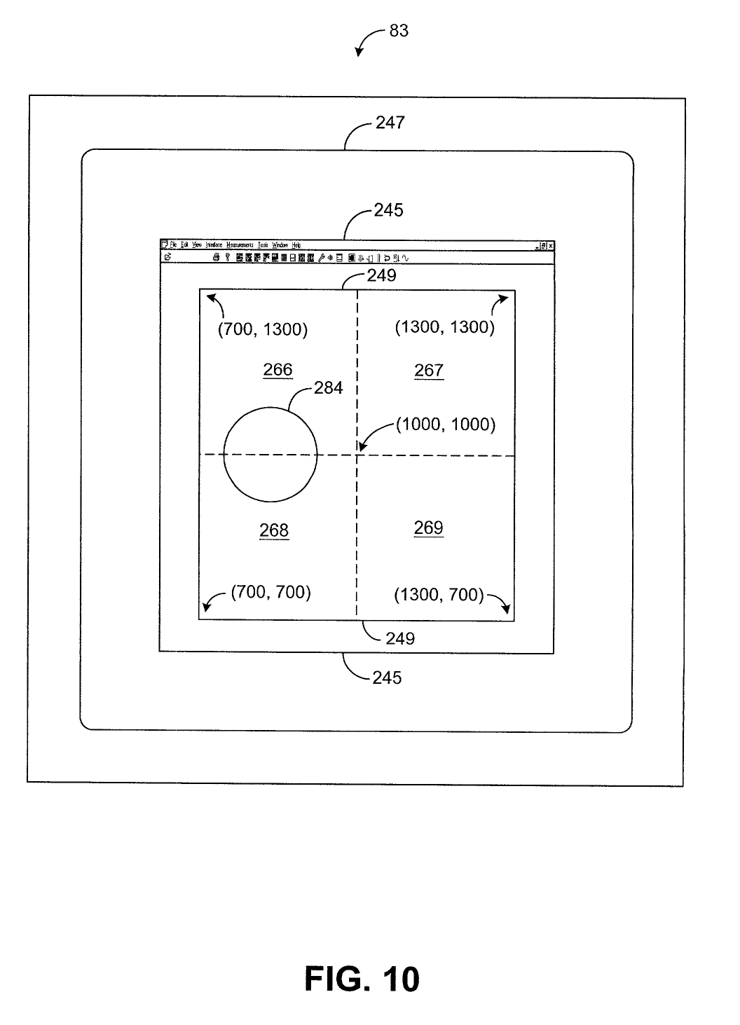

Once the graphical data produced by the application 17 has been rendered to display device 83, as described above, the display device 83 should display an image defined by the foregoing graphical data. This image may be modified by rendering new graphical data from the application 17 via the same techniques described hereinabove. For example, assume that it is desirable to display a new 3D object 284 on the screen 247, as shown by FIG. 10. In this example, assume that an upper half of the object 284 is to be displayed in the portion 266 and that a bottom half of the object is to be displayed in the portion 268. Thus, the object is not to be displayed in portions 267 and 269.

In the foregoing example, graphical data defining the object 284 is transmitted from client 52 to master pipeline 55. The master pipeline 55 transmits this graphical data to each of the slave pipelines 56-59. Since the object 284 is not to be displayed within portions 267 and 269, the screen coordinates of the object 284 should be outside of the ranges rendered by pipelines 57 and 59. Thus, slave pipelines 57 and 59 should discard the graphical data without rendering it to frame buffers 67 and 69. Preferably, bounding box techniques and/or other data optimization techniques are employed to discard the graphical data defining the object 284 before the coordinates of this graphical data are translated to screen relative by pipelines 57 and 59 and/or before other significant processing is performed on this data by pipelines 57 and 59.

Since the top half of the object 284 is to be displayed within portion 266, the screen coordinates of the object should be within the range rendered by pipeline 56 (i.e., from screen coordinates (700, 1000) to (1000, 1300)). Thus, slave pipeline 56 should render the graphical data defining the top half of the object 284 to frame buffer 66. However, since the bottom half of the object 284 is not to be displayed within portion 266, the screen coordinates of the bottom half of the object 284 should be outside of the range rendered by the pipeline 56. Thus, the slave pipeline 56 should discard the graphical data defining the bottom half of the object 284 without rendering this data to frame buffer 66. Preferably, bounding box techniques and/or other data optimization techniques are employed to discard the graphical data defining the bottom half of the object 284 before the coordinates of this graphical data are translated to screen relative by pipeline 56 and/or before other significant processing is performed on this data by pipeline 56.

Since the bottom half of the object 284 is to be displayed within portion 268, the screen coordinates of the object should be within the range rendered by pipeline 58 (i.e., from screen coordinates (700, 700) to (1000, 1000)). Thus, slave pipeline 58 should render the graphical data defining the bottom half of the object 284 to frame buffer 68. However, since the top half of the object 284 is not to be displayed within portion 268, the screen coordinates of the top half of the object 284 should be outside of the range rendered by the pipeline 58. Thus, the slave pipeline 58 should discard the graphical data defining the top half of the object 284 without rendering this data to frame buffer 68. Preferably, bounding box techniques and/or other data optimization techniques are employed to discard the graphical data defining the top half of the object 284 before the coordinates of this graphical data are translated to screen relative by pipeline 58 and/or before other significant processing is performed on this data by pipeline 58.

As described hereinbefore, the graphical data stored in frame buffers 65-69 should be composited by compositor 76 and rendered to display device 83. The display device 83 should then update the image displayed by the screen 247 such that the object 284 is displayed within portions 266 and 268, as shown by FIG. 10.

Since each pipeline 55-59 renders only a portion of the graphical data defining each image displayed by display device 83, the total time for rendering the graphical data to display device 83 can be significantly decreased, thereby resulting in increased efficiency for the system 50. Thus, in the optimization mode, the speed at which graphical data is rendered from the client 52 to the display device 83 should be maximized. This increase in efficiency is transparent to the application 17, in that the application 17 does not need to be aware of the configuration of the pipelines 55-59 to operate correctly. Thus, the application 17 does not need to be modified to operate successfully in either conventional system 15 or in the system 50 depicted by FIG. 3.

Super-Sampling Mode

Referring to FIG. 3, the operation and interaction of the client 52, pipelines 55-59, and the compositor 76 will now be described in more detail while each of the pipelines 56-59 is operating in the super-sampling mode. In the super-sampling mode, the graphical data transmitted from the client 52 is super-sampled to enable anti-aliasing of the image produced by display device 83.

For illustrative purposes assume that the application 17, as described hereinabove for the optimization mode, issues a function call for creating an X window 245 having a 3D image displayed within the region 249 of the X window 245, as shown by FIG. 7. In the super-sampling mode, the pipelines 55-59 perform the same functionality as in the optimization mode except for a few differences, which will be described in more detail hereinbelow. More specifically, the client 52 transmits to the master pipeline 55 a command to render the X window 245 and a command to render a 3D image within portion 249 of the X window 245. The command for rendering the X window 245 should include 2D graphical data defining the X window 245, and the command for rendering the 3D image within the X window 245 should include 3D graphical data defining the 3D image to be displayed within region 249. The master pipeline 55 renders the 2D data defining the X window 245 to frame buffer 65 and transmits the 3D data defining the 3D image to slave pipelines 56-59, as described hereinabove for the optimization mode. The master pipeline 55 also assigns the chroma-key to each pixel that is rendered to frame buffer 65 and that is within portion 249.

The slave controller 261 transmits inputs to the slave pipelines 56-59 indicating the range of screen coordinate values that each slave 56-59 is responsible for rendering, as described hereinabove for the optimization mode. Each slave pipeline 56-59 discards the graphical data outside of the pipeline's responsibility, as previously described for the optimization mode. However, unlike in the optimization mode, the pipelines 56-59 super-sample the graphical data rendered by the pipeline 56-59 to frame buffers 66-69, respectively. In super-sampling the graphical data, the number of pixels used to represent the image defined by the graphical data is increased. Thus, a portion of the image represented as a single pixel in the optimization mode is instead represented as multiple pixels in the super-sampling mode. In other words, the image defined by the super-sampled data is blown up or magnified as compared to the image defined by the data prior to super-sampling. The graphical data super-sampled by pipelines 56-59 is rendered to frame buffers 66-69, respectively.

The graphical data stored in frame buffers 65-69 is then transmitted to compositor 76, which then combines or composites the graphical data into a single data stream for display device 83. Before compositing or combining the graphical data, the compositor 76 first processes the super-sampled data received from frame buffers 66-69. More specifically, the compositor 76 reduces the size of the image defined by the super-sampled data back to the size of the image prior to the super-sampling performed by pipelines 56-59. In reducing the size of the image defined by the super-sampled data, the compositor 76 averages or blends the color values of each set of super-sampled pixels that is reduced to a single pixel such that the resulting image defined by the processed data is anti-aliased.

As an example, assume that a portion of the graphical data originally defining a single pixel is super-sampled by one of the pipelines 56-59 into four pixels. When the foregoing portion of the graphical data is processed by compositor 76, the four pixels are reduced to a single pixel having a color value that is an average or a blend of the color values of the four pixels. By performing the super-sampling and blending for each pixel defined by the graphical data transmitted to pipelines 56-59, the entire image defined by this data is anti-aliased. Note that super-sampling of the single pixel into four pixels as described above is exemplary, and the single pixel may be super-sampled into numbers of pixels other than four in other examples. Further, any conventional technique and/or algorithm for blending pixels to form a jitter enhanced image may be employed by the compositor 76 to improve the quality of the image defined by the graphical data stored within frame buffers 66-69.

To better illustrate the operation of the system 50 in the super-sampling mode, assume that the application 17 issues a command to display the 3D object 284 depicted in FIG. 10. In the this example, graphical data defining the object 284 is transmitted from client 52 to master pipeline 55. The master pipeline 55 transmits this graphical data to each of the slave pipelines 56-59. Since the object 284 is not to be displayed within portions 267 and 269, the screen coordinates of the object 284 should be outside of the ranges rendered by pipelines 57 and 59. Thus, slave pipelines 57 and 59 should discard the graphical data without rendering it to frame buffers 67 and 69. Preferably, bounding box techniques and/or other data optimization techniques are employed to discard the graphical data defining the object 284 before the coordinates of this graphical data are translated to screen relative by pipelines 57 and 59 and/or before other significant processing is performed on this data by pipelines 57 and 59.

Since the top half of the object 284 is to be displayed within portion 266, the screen coordinates of the object should be within the range rendered by pipeline 56 (i.e., from screen coordinates (700, 1000) to (1000, 1300)). Thus, slave pipeline 56 should render the graphical data defining the top half of the object 284 to frame buffer 66. However, since the bottom half of the object 284 is not to be displayed within portion 266, the screen coordinates of the bottom half of the object 284 should be outside of the range rendered by the pipeline 56. Thus, the slave pipeline 56 should discard the graphical data defining the bottom half of the object 284 without rendering this data to frame buffer 66. Preferably, bounding box techniques and/or other data optimization techniques are employed to discard the graphical data defining the bottom half of the object 284 before the coordinates of this graphical data are translated to screen relative by pipeline 56 and/or before other significant processing is performed on this data by pipeline 56.

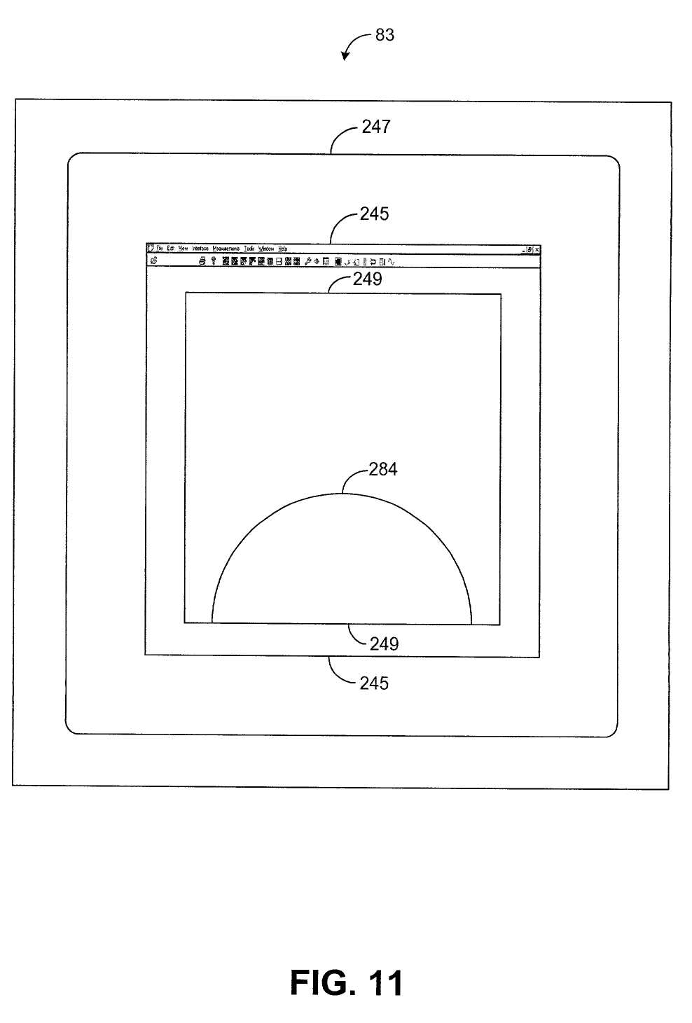

In rendering the top half of the object 284, the pipeline 56 super-samples the data defining the top half of object 284 before storing this data in frame buffer 66. For illustrative purposes, assume that each pixel defining the top half of object 284 is super-sampled by pipeline 56 into four pixels. Thus, if the super-sampled data stored in frame buffer 66 were somehow directly rendered in region 249 without the processing performed by compositor 76, the image displayed by display device 83 should appear to be magnified as shown in FIG. 11.

Since the bottom half of the object 284 is to be displayed within portion 268, the screen coordinates of the object should be within the range rendered by pipeline 58 (i.e., from screen coordinates (700, 700) to (1000, 1000)). Thus, slave pipeline 58 should render the graphical data defining the bottom half of the object 284 to frame buffer 68. However, since the top half of the object 284 is not to be displayed within portion 268, the screen coordinates of the top half of the object 284 should be outside of the range rendered by the pipeline 58. Thus, the slave pipeline 58 should discard the graphical data defining the top half of the object 284 without rendering this data to frame buffer 68. Preferably, bounding box techniques and/or other data optimization techniques are employed to discard the graphical data defining the top half of the object 284 before the coordinates of this graphical data are translated to screen relative by pipeline 58 and/or before other significant processing is performed on this data by pipeline 58.

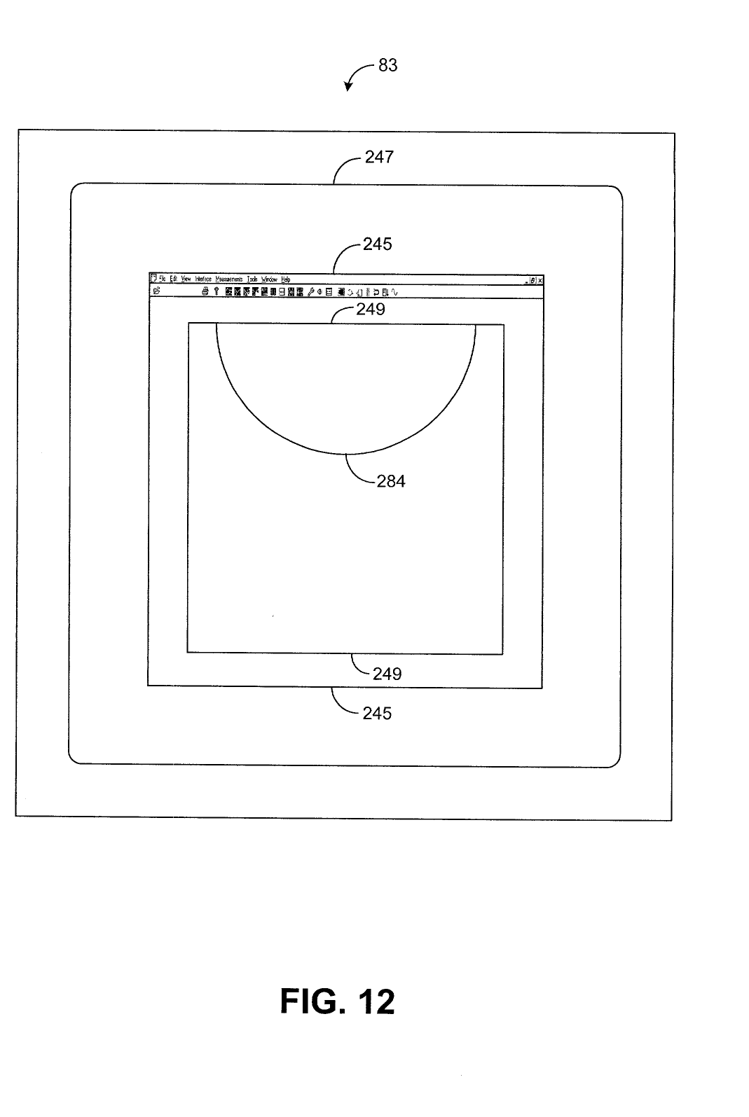

In rendering the bottom half of the object 284, the pipeline 58 super-samples the data defining the bottom half of object 284 before storing this data in frame buffer 68. For illustrative purposes, assume that each pixel defining the bottom half of object 284 is super-sampled by pipeline 58 into four pixels. Thus, if the super-sampled data stored in frame buffer 68 were somehow directly rendered in region 249 without the processing performed by compositor 76, the image displayed by display device 83 should appear to be magnified as shown in FIG. 12.

The compositor 76 is configured to blend the graphical data in frame buffers 66-69 and to composite or combine the blended data and the graphical data from frame buffer 65 such that the screen 247 displays the image shown by FIG. 10. In particular, the compositor 76 blends into a single pixel each set of four pixels that were previously super-sampled from the same pixel by pipeline 56. This blended pixel should have a color value that is a weighted average or a blend of the color values of the four super-sampled pixels. Furthermore, the compositor 76 also blends into a single pixel each set of four pixels that were previously super-sampled from the same pixel by pipeline 58. This blended pixel should have a color value that is a weighted average or a blend of the color values of the four super-sampled pixels. Thus, the object 284 should appear in anti-aliased form within portions 266 and 268, as depicted in FIG. 10.

The super-sampling performed by pipelines 56-59 should improve the quality of the image displayed by display device 83. Furthermore, since each pipeline 56-59 is responsible for rendering only a portion of the image displayed by display device 83, similar to the optimization mode, the speed at which a super-sampled image is rendered to display device 83 can be maximized.

Jitter Mode

Referring to FIG. 3, the operation and interaction of the client 52, pipelines 55-59, and the compositor 76 will now be described in more detail while each of the pipelines 55-59 is operating in the jitter mode. In the jitter mode, each pipeline 56-59 is responsible for rendering the graphical data defining the entire 3D image to be displayed within region 249. Thus, each pipeline 56-59 refrains from discarding portions of the graphical data based on inputs received from slave controller 261, as described hereinabove for the optimization and super-sampling modes. Instead, each pipeline 56-59 renders the graphical data for each portion of the image visible within the entire region 249.

However, each pipeline 56-59 adds a small offset to the coordinates of each pixel rendered by the pipeline 56-59. The offset applied to the pixel coordinates is preferably different for each different pipeline 56-59. The different offsets applied by the different pipelines 56-59 can be randomly generated by each pipeline 56-59 and/or can be pre-programmed into each pipeline 56-59. After the pipelines 56-59 have applied the offsets to the pixel coordinates and have rendered to frame buffers 66-69, respectively, the compositor 76 combines the graphical representation defined by the data in each frame buffer 66-69 into a single representation that is rendered to the display device 83 for displaying. In combining the graphical representations, the compositor 76 averages or blends the color values at the same pixel locations in frame buffers 66-69 into a single color value for the same pixel location in the final graphical representation that is to be rendered to the display device 83.

The aforementioned process of averaging multiple graphical representations of the same image should produce an image that has been jitter enhanced. The drawback to enhancing the image quality in this way is that each pipeline 56-59 renders the entire image to be displayed within region 249 instead of just a portion of such image as described in the optimization and super-sampling modes. Thus, the amount of time required to render the same image may be greater for the jitter mode as opposed to the optimization and super-sampling modes. However, as compared to conventional systems 15 and 41, the amount of time required for the system 50 to render a jitter enhanced image should be significantly less than the amount of time required for either of the conventional systems 15 or 41 to produce the same jitter enhanced image.

In this regard, in performing jitter enhancing in a conventional system 15 or 41, a single pipeline 23 or 36-39 usually renders the graphical data defining an image multiple times to enable jitter enhancement to occur. Each time the pipeline 23 or 36-39 renders the graphical data, the pipeline 23 or 36-39 applies a different offset. However, in the illustrated environment, a different offset is applied to the same graphical data via multiple pipelines 56-59. Therefore, to achieve the same level of jitter enhancement of an image, it is not necessary for each pipeline 56-59 of system 50 to render the graphical data defining the image the same number of times as the single conventional pipeline 23 or 36-39. Thus, the system 50 should be able to render an jitter enhanced image faster than conventional systems 15 and 41.

To better illustrate the operation of the system 50 in the jitter mode, assume that the application 17 issues a command to display the 3D object 284 depicted in FIG. 10. In this example, graphical data defining the object is transmitted from the client 52 to the master pipeline 55. The master pipeline 55 transmits this graphical data to each of the slave pipelines 56-59. Each of the slave pipelines 56-59 renders the graphical data defining the 3D object 284 to frame buffers 66-69, respectively. In rendering the graphical data, each pipeline 56-59 adds a small offset to each set of coordinate values within the graphical data defining the object 284. The offset added by each pipeline 56-59 is preferably different and small enough such that the graphical representations of the object, as defined by frame buffers 66-69, would substantially but not exactly overlay one another, if each of these representations were displayed by the same display device 83.

As an example, pipeline 56 may add the value of 0.1 to each coordinate rendered by the pipeline 56, and pipeline 57 may add the value of 0.2 to each coordinate rendered by the pipeline 56. Further, pipeline 58 may add the value of 0 to each coordinate rendered by the pipeline 58, and the pipeline 59 may add the value of −0.2 to each coordinate rendered by the pipeline 59. Note that it is not necessary for the same offset to be added to each coordinate rendered by a particular pipeline 56-59. For example, one of the pipelines 56-59 could be configured to add the value of 0.1 to each x-coordinate value rendered by the one pipeline 56-59 and to add the value of 0.2 to each y-coordinate value and z-coordinate value rendered by the one pipeline 56-59.

The graphical data in frame buffers 66-69 is transmitted to compositor 76, which forms a single graphical representation of the object 284 based on each of the graphical representations from frame buffers 66-69. In this regard, the compositor 76 averages or blends into a single color value the color values of each pixel from frame buffers 66-69 having the same screen relative coordinate values. Each color value calculated by the compositor 76 is then assigned to the pixel having the same coordinate values as the pixels that were averaged or blended to form the color value calculated by the compositor 76.

As an example, assume that color values stored in frame buffers 66-69 for the pixel having the coordinate values (1000, 1000, 0) are a, b, c, and d, respectively, in which a, b, c, and d represent four different numerical values. In this example, the compositor 76 may calculate a new color value, n, based on the following equation: n=(a+b+c+d)/4. This new color value, n, is then transmitted to display device 83 as the color value for the pixel having coordinates (1000, 1000, 0). Note that a different algorithm may be used to calculate the new color value and that different weightings may be applied to the values being averaged.

By performing the above-described process for each pixel represented in frame buffers 66-69, the compositor 76 produces graphical data defining a jitter enhanced image of the 3D object 284. This data is rendered to the display device 83 to display the jitter enhanced image of the object 284.

It should be noted that it is not necessary for each of the pipelines 56-59 to operate in only one mode of operation. For example, it is possible for the pipelines 56-59 to operate in both the optimization mode and the jitter mode. As an example, the region 249 could be divided into two portions according to the techniques described herein for the optimization mode. The pipelines 56 and 57 could be responsible for rendering graphical data within one portion of the region 249, and pipelines 58 and 59 could be responsible for rendering within the remaining portion of the region 249. Furthermore, the pipelines 56 and 57 could render jitter enhanced and/or anti-aliased images within their portion of region, and pipelines 58 and 59 could render jitter enhanced and/or anti-aliased images within the remaining portion of region 249. The modes of pipelines 56-59 may be mixed according to other combinations in other embodiments.

Furthermore, it is not necessary for the application 17 to be aware of which mode or combination of modes are being implemented by pipelines 55-59, since the operation of the application 17 is the same regardless of the implemented mode or combination of modes. In other words, the selection of the mode or modes implemented by the pipelines 55-59 can be transparent to the application 17.

It should be noted that there are a variety of methodologies that may be employed to enable the selection of the mode or modes performed by the system 50. In the preferred embodiment, a user is able to provide inputs via input device 115 of client 52 (FIG. 4) indicating which mode or modes the user would like the system 50 to implement. The client 52 is designed to transmit the user's mode input to master pipeline 55 over LAN 62. The slave controller 261 of the master pipeline 55 (FIG. 5) is designed to then provide appropriate input to each slave pipeline 56-59 instructing each slave pipeline 56-59 which mode to implement based on the mode input received from client 52. The slave controller 261 also transmits control information to compositor 76 via connection 331 (FIG. 3) indicating which mode is being implemented by each pipeline 56-59. The compositor 76 then utilizes this control information to appropriately process the graphical data from frame buffers 76, as further described herein. There are various other methodologies and configurations that may be employed to provide the slave pipelines 56-59 and/or compositor 76 with the necessary mode information for enabling the pipelines 56-59 and compositor 76 to operate as desired. For example, the control information may be included in the data transmitted from the master pipeline 55 to the slave pipelines 56-59 and then from the slave pipelines 56-59 to the compositor 76.

It should be noted that master pipeline 55 has been described herein as only rendering 2D graphical data. However, it is possible for master pipeline 55 to be configured to render other types of data, such as 3D image data, as well. In this regard, the master pipeline 55 may also include an OGL daemon, similar to the OGL daemon 205 within the slave pipelines 56-59. The purpose for having the master pipeline 55 to only execute graphical commands that do not include 3D image data is to reduce the processing burden on the master pipeline 55, since the master pipeline 55 performs various functionality not performed by the slave pipelines 56-59. In this regard, executing graphical commands including only 2D image data is generally less burdensome than executing commands including 3D image data. However, it may be possible and desirable in some implementations to allow the master pipeline 55 to share in the execution of graphical commands that include 3D image data. Furthermore, it may also be possible and desirable in some implementations to allow the slave pipelines 56-69 to share in the execution of graphical commands that do not include 3D image data (e.g., commands that only include 2D graphical data).

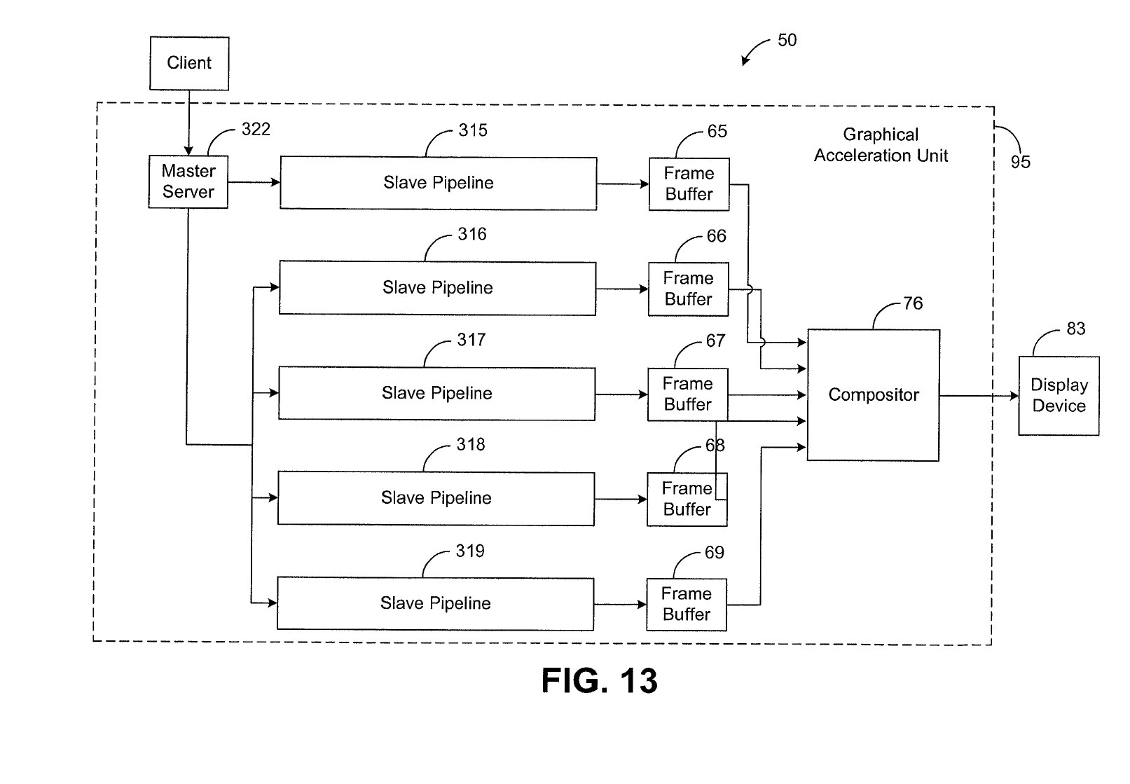

In addition, a separate computer system may be used to provide the functionality of controlling the graphics pipelines. For example, FIG. 13 depicts another embodiment of the graphical acceleration unit 95. This embodiment includes multiple pipelines 315-319 configured to render data similar to pipelines 55-59, respectively. However, a separate computer system, referred to as master server 322, is employed to route graphical data received from client 52 to pipelines 315-319 and to control the operation of pipelines 315-319, similar to how slave control 261 of FIG. 5 controls the operation of pipelines 56-59. Other configurations may be employed without departing from the principles discussed herein. Furthermore, as previously set forth, it is not necessary to implement each pipeline 55-59 and the client 52 via a separate computer system. A single computer system may be used to implement multiple pipelines 55-59 and/or may be used to implement the client 52 and at least one pipeline 55-59.

It should be further noted that the illustrated environment has been described as utilizing X Protocol and OpenGL Protocol to render graphical data. However, other types of protocols may be utilized without departing from the principles of the illustrated environment.

Single Logical Screen Implementation

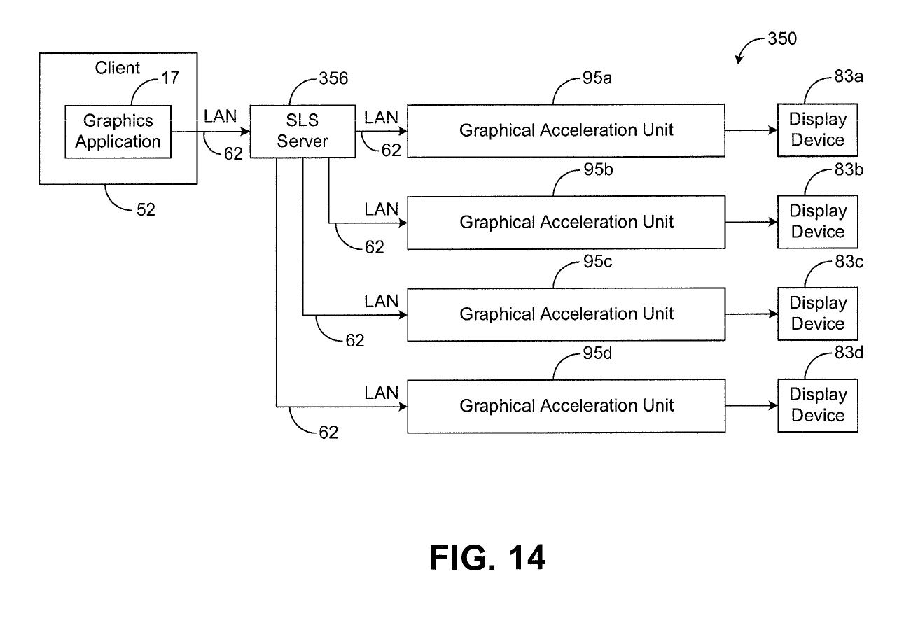

The graphical acceleration unit 95 described herein may be utilized to implement a single logical screen (SLS) graphical system, similar to the conventional system 41 shown in FIG. 2. As an example, refer to FIG. 14, which depicts an SLS graphical display system 350 in accordance with the illustrated environment. The system 350 includes a client 52 storing the graphical application 17 that produces graphical data to be rendered, as described hereinabove. Any graphical command produced by the application 17 is preferably transmitted to SLS server 356, which may be configured similarly to the conventional SLS server 45 of FIG. 2. More specifically, the SLS server 356 is configured to interface each command received from the client 52 with multiple graphical acceleration units 95a-95d similar to how conventional SLS server 45 interfaces commands received from client 42 with each graphics pipeline 36-39. The SLS server 356 may be implemented in hardware, software, or a combination thereof, and in the preferred embodiment, the SLS server 356 is implemented as a stand-alone computer workstation or is implemented via a computer workstation that is used to implement the client 52. However, there are various other configurations that may be used to implement the SLS server 356 without departing from the principles of the illustrated environment.

Each of the graphical acceleration units 95a-95d, according to the techniques described herein, is configured to render the graphical data received from SLS server 356 to a respective one of the display devices 83a-83d. Note that the configuration of each graphical acceleration unit 95a-95d may be identical to the graphical acceleration unit 95 depicted by FIG. 3 or FIG. 13, and the configuration of each display device 83a-83d may be identical to the display device 83 depicted in FIGS. 3 and 13. Moreover, an image defined by the graphical data transmitted from the application 17 may be partitioned among the display devices 83a-83d such that the display devices 83a-83d collectively display a single logical screen similar to how display devices 31-34 of FIG. 2 display a single logical screen.

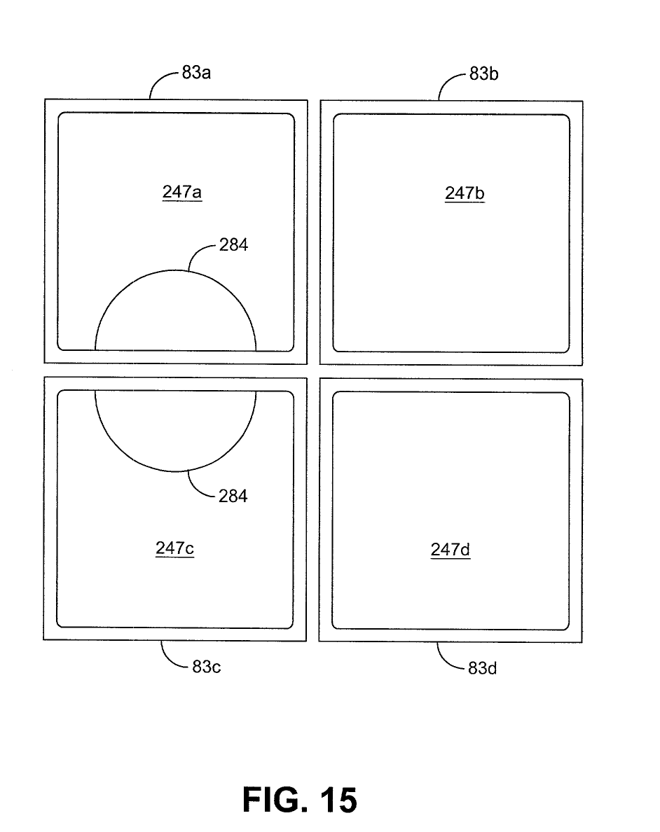

To better illustrate the operation of the system 350, assume that a user would like to display an image of the 3D object 284 (FIG. 10) via the display devices 83a-83d as a single logical screen. FIG. 15 depicts how the object 284 may be displayed by display devices 83a-83d in such an example. More specifically, in FIG. 15, the display device 83a displays the top half of the object 284, and the display device 83c displays the bottom half of the object 284.

In the foregoing example, the client 52 transmits a command for displaying the object 284. The command includes the graphical data defining the object 284 and is transmitted to SLS server 356. The SLS server 356 interfaces the command with each of the graphical acceleration units 95a-95d. Since the object 284 is not to be displayed by display devices 83b and 83d, the graphical acceleration units 95b and 95d fail to render the graphical data from the command to display devices 83b and 83d. However, graphical acceleration unit 95a renders the graphical data defining the top half of the object 284 to display device 83a, and graphical acceleration unit 95c renders the graphical data defining the bottom half of the object 284 to display device 83c. In response, the display device 83a displays the top half of the object 284, and the display device 83c displays the bottom half of the object 284, as shown by FIG. 15.

Note that the graphical acceleration units 95a and 95c may render their respective data based on any of the modes of operation previously described. For example, the master pipeline 55 (FIG. 3) of the graphical acceleration unit 95a preferably receives the command for rendering the object 284 and interfaces the graphical data from the command to slave pipelines 56-59 (FIG. 3) of the graphical acceleration unit 95a. These pipelines 56-59 may operate in the optimization mode, the super-sampling mode, and/or the jitter mode, as previously described hereinabove, in rendering the graphical data defining the top half of the object 284.

In addition, the master pipeline 55 (FIG. 3) of the graphical acceleration unit 95c preferably receives the command for rendering the object 284 and interfaces the graphical data from the command to slave pipelines 56-59 (FIG. 3) of the graphical acceleration unit 95c. These pipelines 56-59 may operate in the optimization mode, the super-sampling mode, and/or the jitter mode, as previously described hereinabove, in rendering the graphical data defining the bottom half of the object 284.

Note that the master pipeline 55 (FIG. 3) of each graphical acceleration unit 95a-95d may employ bounding box techniques to optimize the operation of the system 350. In particular, the master pipeline 55 (FIG. 3) may analyze bounding box data as previously described hereinabove to determine quickly whether the graphical data associated with a received command is to be rendered to the display device 83a-83d that is coupled to the unit 95a-95d. If the graphical data of the received command is not to be rendered to the display device 83a-83d coupled to the graphical acceleration unit 95a-95d, then the master server 55 of the graphical acceleration unit 95a-95d may be configured to discard the command before transmitting the graphical data of the command to any of the slave pipelines 56-59 and/or before performing any significant processing of the command. However, if any of the graphical data of the received command is to be rendered to the display device 83a-83d coupled to the graphical acceleration unit 95a-95d, then the unit 95a-95d can be configured to further process the command as described herein.

It should be noted that the system 350 could be scaled as needed in order to achieve a desired level of processing speed and/or image quality. In this regard, the number of graphical acceleration units 95a-95d and associated display devices 83a-83d can be increased or decreased as desired depending on how large or small of a single logical screen is desired. Further, the number of slave pipelines 56-59 (FIG. 3) within each graphical acceleration unit 95a-95d can be increased or decreased based on how much processing speed and/or image quality is desired for each display device 83a-83d. Note that the number of slave pipelines 56-59 within each unit 95a-95d does not have to be the same, and the modes and/or the combinations of modes implemented by each unit 95a-95d may be different.

Furthermore, in the embodiment shown by FIG. 3, mode inputs from the user were provided to the master pipeline 55, which controlled the mode of operation of the slave pipelines 55-59 and the compositor 76. In the embodiment shown by FIG. 14, such inputs may be similarly provided to the master pipeline 55 within each graphical acceleration unit 95a-95d via the client 52 and the SLS server 356. However, as previously set forth hereinabove, there are various other methodologies that may be employed to control the mode of operation of the pipelines 56-59 and the compositor 76.

Preferred Embodiment

Having described an illustrative environment of a system embodying the present invention, reference is not made to the preferred embodiment of the present invention. In this regard, is should be understood that the foregoing discussion should not be viewed as limiting upon the invention, but rather as illustrative of only one system in which the present invention may reside and operate.

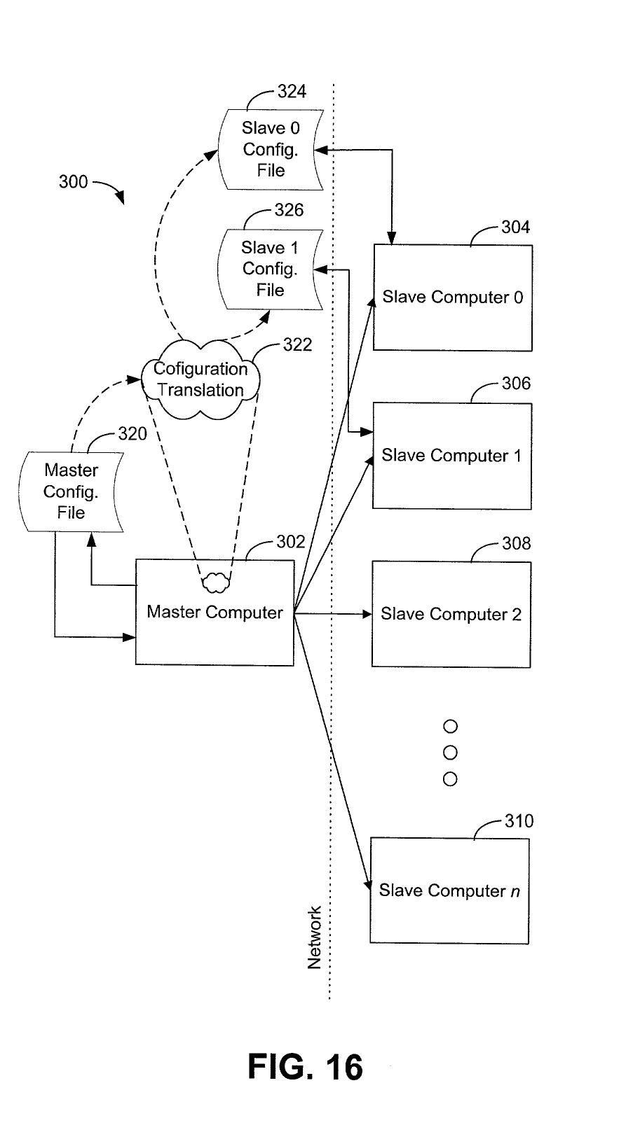

Having described a particular embodiment of a multiple-processor, single display system that may utilize the present invention, reference will now be made to various embodiments of the present invention itself. In this regard, reference is made to FIG. 16, which is a diagram illustrating certain principal components of the system 300 constructed in accordance with one embodiment of the invention. As summarized above, the present invention relates to systems and methods for configuring multiple computers to cooperatively operate to process and render a single display. The embodiment of FIG. 16 illustrates a two-tiered system having a master computer 302 and a plurality of slave computers 304, 306, 308, and 310 that may inter-communicate across a network.

In accordance with one aspect of the invention, the master computer 302 is responsible for configuring each of the slave computers 304, 306, 308, and 310 such that they operate cooperatively to render a single display (not shown). It should be appreciated that the configuration of each slave computer 304, 306, 308, and 310 need not be identical, but rather compatible. In this regard, and as previously discussed, there are certain modes and graphics configurations (e.g., “stereo” mode versus “mono” mode) whereby the various slave computers may be incompatibly configured. The configuration system and methodology of the present invention ensures compatible operation among the plurality of slave computers. Further, it should be appreciated that the graphics cards that are present in each of the slave computers need not be identical.

In essence, the master computer 302 receives instructions regarding the configuration for the graphics display, translates that configuration information into a format that is appropriate for each of the individual slave computers, and then communicates that individualized configuration information to each of the slave computers. By way of example, slave computer 304 may have a different graphics card than slave computer 306. With knowledge of these differences, the master computer 302 may specify the configuration information for each of the slave computers 304 and 306 in a slightly different fashion. Implementation details such as these will be appreciated by persons skilled in the art and are not deemed to be limiting upon the present invention. Accordingly, such implementation details need not be described herein.

In accordance with one embodiment of the invention, configuration information may be stored in a master configuration file 320. Preferably, such a master configuration file 320 will be stored in a predetermined location and using a predetermined file name, such that the master computer 302 can readily retrieve this information. The master computer 302 may then operate to translate the configuration information stored in this master configuration file 320 into distinct configuration information that is communicated separately to each of the slave computers 304, 306, 308, and 310. In this regard, the master computer 302 may include a program segment or process 322 that operates to perform such a configuration translation. This process 322 may then be configured to operate to output, for example, separate configuration files 324 and 326 for the separate slave computers 304 and 306, respectively. In such an embodiment, the slave configuration files 324 and 326 may be stored in a predetermined or known location in reference to each slave computer 304 and 306, such that each slave computer can retrieve this information. In operation, a slave computer 304 may retrieve the configuration information within slave configuration file 324 and use that information to configure its graphics card accordingly. The details regarding such an initialization process are well known by the persons skilled in the art, and therefore need not be described herein.

In an alternative embodiment (not specifically illustrated) the master computer 302 may perform a similar translation of the configuration information, but rather than save individual slave configuration files 324 and 326, the master computer 302 may instead communicate this configuration information directly to each slave computer. One way of communicating this information to the slave computers is through a communication socket. In such a system, for example, a slave system (after initialization) may instruct the master computer 302 to communicate configuration information to the slave computer 304 through a specified port or socket. The slave computer 304 may thereafter poll that socket or communication port to receive the configuration information. Once received, the slave computer may then configure itself accordingly.

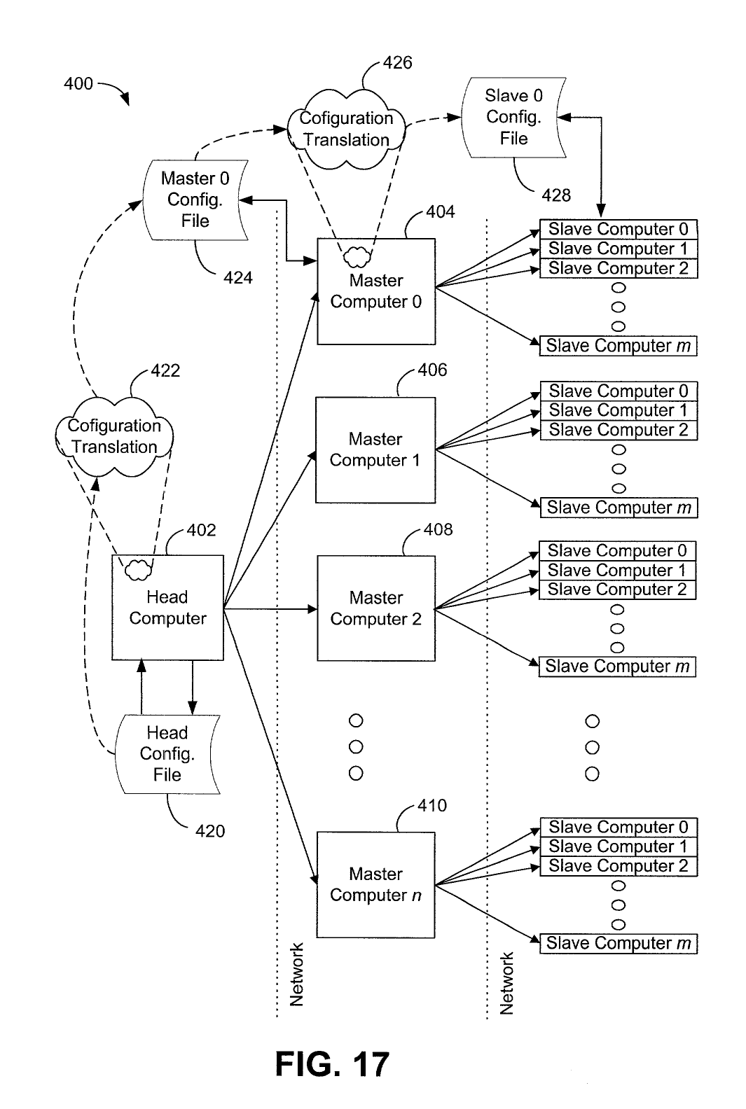

Reference is now made to FIG. 17, which is a diagram illustrating certain principal components of a system constructed in accordance with an alternative embodiment of the present invention. The general operation of the embodiment illustrated in FIG. 17 is similar to that illustrated in FIG. 16, except that it has been expanded to a three-tiered system, as opposed to a two-tiered system. In a system such as that illustrated in FIG. 17, there is a head computer 402, and plurality of master computers 404, 406, 408, and 410, and a plurality of s lave computers associated with each master computer. In this regard, the various pluralities of slave computers may be referred to as clusters, where each cluster of slave computers is associated with a single display (not shown). Thus, each master computer 404, 406, 408, and 410 is likewise associated with a single display.

Similar to the operation of the system illustrated in FIG. 16, in operation, the head computer 402 may receive configuration information from a head configuration file 420, which is located in a predetermined location. The head computer 402 may include a code segment or process 422 that performs a translation of the configuration information received from the head configuration file 420. The translation process 422 may be operative to output separate configuration information for each of the plurality of the master computers 404, 406, 408 and 410. As in the embodiment illustrated in FIG. 16, the configuration translation process 422 may output separate and independent master configuration files (e.g., 424), which are associated with each of the master computers. Alternatively, but not specifically illustrated, the translation process 422 may communicate the configuration information to each of the master computers through communication ports or sockets, in a manner such as that discussed above in connection with an alternative embodiment to the system of FIG. 16.

Thereafter, and in a manner similar to that discussed in connection with FIG. 16, each master computer (e.g., 404) may include a code segment or process 426 that translates the configuration information received by that master computer into an appropriate format for further communication to each of the slave computers associated with that master computer. In one embodiment, this translated information may be output to slave configuration files (e.g., 428), or alternatively may be communicated to the various slave computers through communication ports or sockets.

It should be appreciated that, in accordance with the scope and spirit of the present invention, the particular mechanisms for translating this configuration information, and communicating the configuration information to the various master and slave computers may vary. Indeed, what is significant for purposes of the broader concepts and teachings of the present invention is the overall configuration and translation process, which ensures compatible operation among the various slave computers that are configured to drive individual displays.

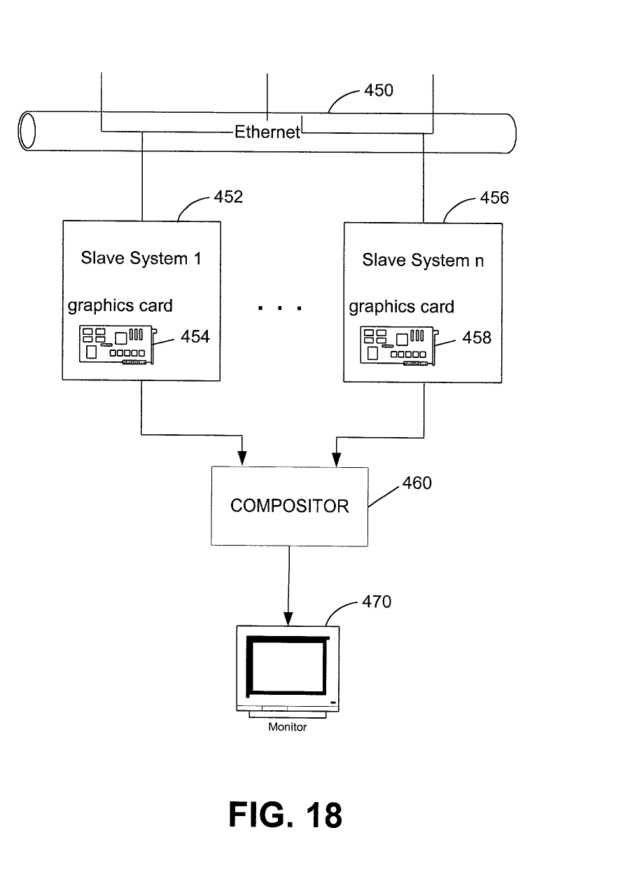

Having described the system-level structure and operation of embodiments of the present invention, reference is made briefly to FIG. 18, which illustrates certain hardware components of the system of FIGS. 16 and 17 in more detail. In this regard, FIG. 18 shows a network 450 and n slave computers (only two specifically illustrated). Each slave computer 452 and 456 includes a graphics card 454 and 458, respectively. As is known, the graphics cards 454 and 458 operate to process graphics information and send an analog (or digital—e.g., DVI, digital video interface) signal to a display.

In a system constructed in accordance with the present invention, the various graphics cards are configured to process and render only a portion of a display screen. The outputs of the respective graphics cards 454 and 458 are sent to a compositor 460, which takes the individual video signals generated by the graphics cards 454 and 458 and generates a single, composite signal that drives a single display 470. As described herein, the present invention relates to the configuration of the various graphics cards 454 and 458 so that that are compatibly configured to generate appropriate video signals to render a single display 470.

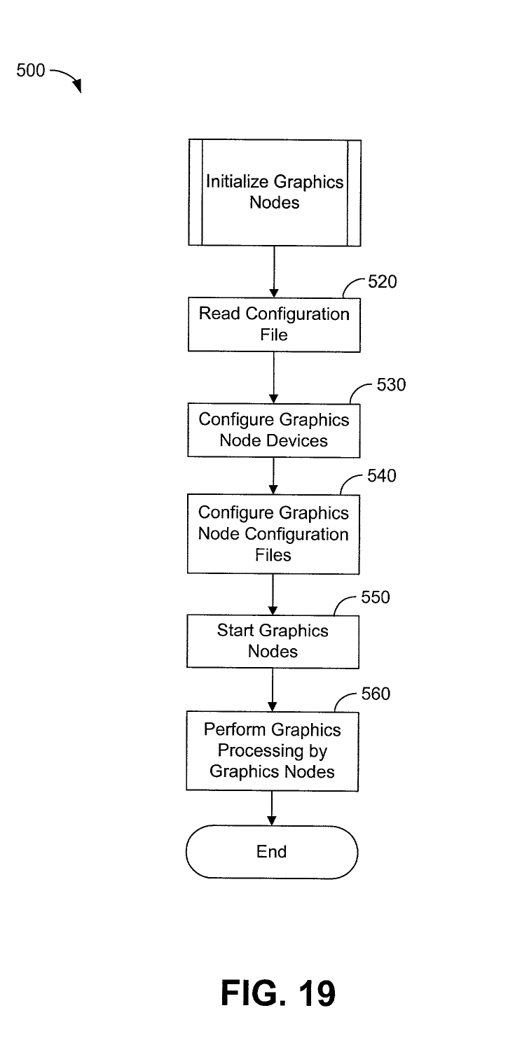

Reference is now made to FIGS. 19, 20, 21, and 22, which are flow charts that depict the top-level functional operation of the system constructed in accordance with the invention. The flow charts illustrated in these drawings have been genericized, such that they illustrate the operation of both a two-tiered system and a three-tiered system. Referring first to the flow chart 500 of FIG. 19, a top-level flow chart is presented, which illustrates the overall system operation. Briefly, this top-level operation consists of various steps that perform an initialization of the various graphic nodes. This initialization is performed for both the master computers (open two-tiered system) and head computers (three-tiered system). In a first step, the master or head computer reads a configuration file (step 520) which specifies various configuration information for the graphics display(s) in that system. From this configuration information, the various master computers configure the individual slave computers, or graphic node devices (step 530). Thereafter, the system configures the various graphic node configuration files (step 540). Thereafter, each of the graphics nodes are started (step 550) based upon their individual configuration information. Thereafter, the graphics processing is performed by the various graphics nodes (step 560). Steps 550 and 560 are conventional steps and need not be described in detail herein.

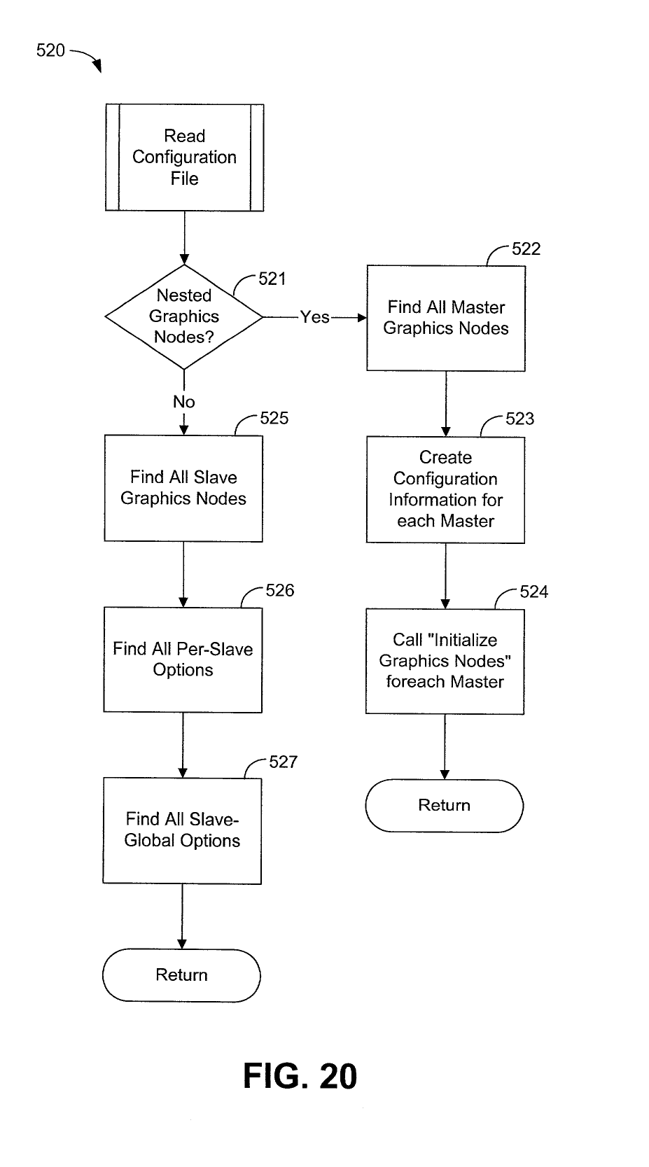

In this regard, the system and method of the present invention relates principally to the performance of steps 520, 530 and 540, and each of these steps is more particularly described in connection with the flow charts of FIGS. 20, 21 and 22, respectively. Reference is now made to FIG. 20, which is a flow chart illustrating the top-level operation of the “Read Configuration File” step 520 illustrated in FIG. 19. As previously 15 mentioned, in accordance with one embodiment of the invention, a main configuration file (e.g., head configuration file or master configuration file) contains configuration information that is used for the configuration of the various slave nodes that are configured to collectively render a single display. As a first step in the process of reading the main configuration file, a determination may be made as to whether there are nested graphics nodes (step 521). In essence, this step makes the determination as to whether the current node is a master computer (in which there are no nested graphics nodes) or a head computer (which includes nested graphics nodes). As illustrated, if the determination is made that there are, indeed, nested graphics nodes, then the method proceeds to find or identify all master graphics nodes (step 522). This step may be performed simply by scanning (by the head computer) through the configuration file to identify the specific, predetermined master nodes (which are specifically defined in the configuration file). This step also identifies any specific configuration options for the ultimate slave computers.

The method then creates configuration information for each master computer (step 523). This step essentially performs a data translation, translating information from, for example, a head configuration file into multiple master configuration files. This step builds each such master configuration file and delivers each such file to the various master computers. Alternatively, in a socket-based implementation, as described above, this step may be configured to deliver the configuration information for each master computer directly to the respective master computers through a communication port or socket. Then, the method proceeds to step 524 which recursively calls the function “initialize graphics nodes” (e.g., the flow chart of FIG. 19) for each master node identified.

If step 521 determines that the current node is a master computer, then the method proceeds to step 525, in which it finds or identifies all slave graphics nodes. This step is similar to step 522, in that the current master computer may evaluate the master configuration file to determine all associated slave nodes (which are defined in the master configuration file), as well as any specific options delineated within the master configuration file for the respective slave nodes. The method then determines, based on the information contained in the master configuration file, all “per-slave” options (step 526). In this respect, various slave computers may be configured with different options, so long as there is intercompatibility among the various slave computers to render a single display. Finally, the method identifies all global slave options (i.e., all options that are applicable to all slave computers operating under the direction of single master computer) (step 527).

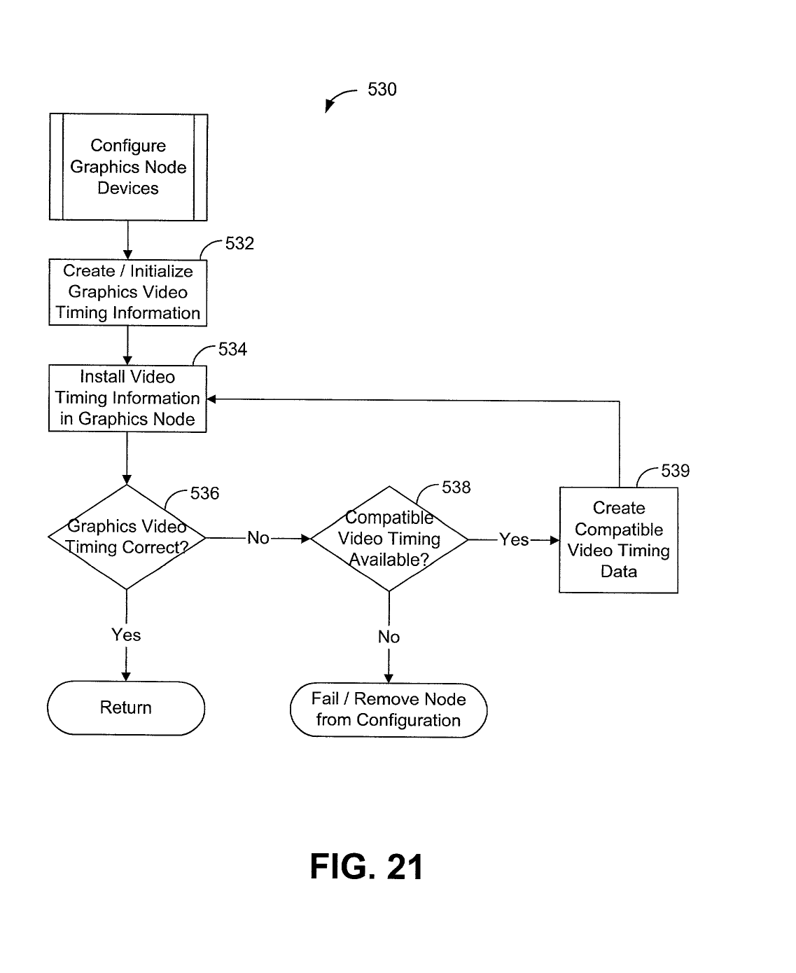

After the configuration files are read and translated, and as illustrated in FIG. 19, the method proceeds to configure the various graphic node devices (step 530). This step essentially performs a data translation process from master to slave nodes in which the various slave nodes are configured to have compatible hardware configurations. This step will function as more particularly illustrated in FIG. 21. In this regard, the method creates or initializes graphics video timing information (step 532). This step essentially defines or sets hardware information such as the screen size, pixel depth, etc. The method may then install video-timing information onto the various slave nodes (step 534). In a preferred environment, the operation of this step either returns a flag or some other value to indicate whether the timing information was correctly installed on the slave node. This flag or value is verified in step 536. If the video timing information was correctly installed, then the function or procedure on step 530 is complete. Otherwise, the system may be configured to determine whether a compatible video timing is available (step 538). If not, the system may be configured to remove that particular node from the graphics processing and rendering process of the graphics for that particular display. Otherwise, the compatible timing information or data may be utilized (step 539) and installed in the graphics node (step 534).

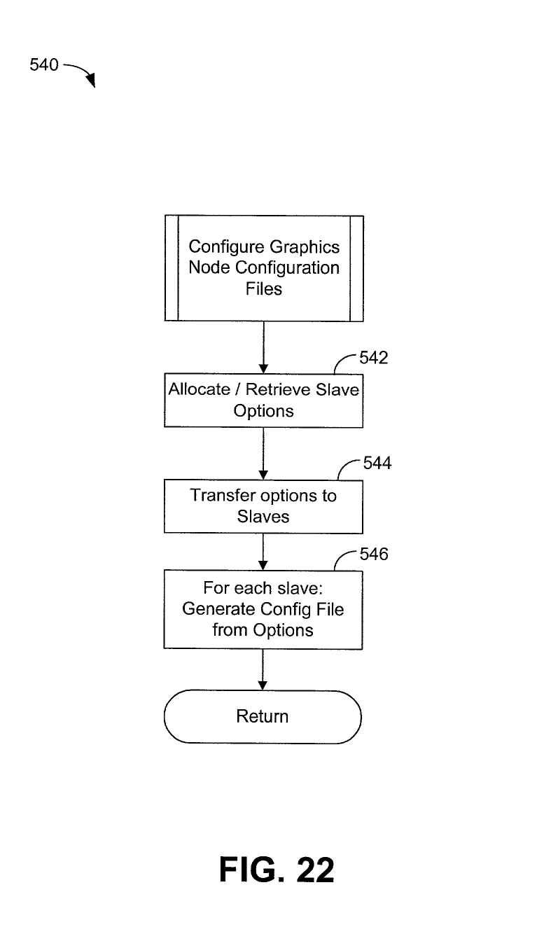

Once the graphics nodes devices have been configured, then, as illustrated in FIG. 19, the graphics node configuration files are configured (step 540). This step is illustrated in further detail in FIG. 22. In this regard, the graphics node configuration files are configured by allocating and retrieving slave options (step 542) transferring these options to the various slave computers (step 544). Then, for each slave computer, each specific configuration file is generated, based up on the retrieved slave options (step 546). This step is essentially the generation of the individual slave configuration files, as was discussed in connection with FIGS. 16 and 17. Alternatively, the slave configuration could be compiled and communicated directly to the various slave computers through a communication port or socket.

In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

Example Configuration Files and Options

To further the understanding of the foregoing discussion, specific illustrations will now be presented, regarding a preferred configuration syntax. The invention, however, it not limited to the syntax or configuration conventions presented below, as they are merely illustrative. In this regard, the following listing is an example of a master configuration file, which may be used to specify certain graphics configuration operations in accordance with one embodiment of the invention.

[ServerOptions opt1 [val] ... optn [val]]
SLSd

<slave_spec>
<slave_spec>
...
[SlaveLayout <layout_options>]
[SlaveServerOptions opt1 [val] ... optn [val]]
[SlaveScreenOptions opt1 [val] ... optn [val]]
[SlaveEnvironment var1=val ... varn=val]
[DefaultVisual

[Depth <n>]
[Class

{PseudoColor|DirectColor|TrueColor|GrayScale}]

[Layer {Image | Overlay}]
[Transparent]

[ScreenOptions opt1 [val] ... optn [val]]

layout_options ::= <slsd_mode> | <slsd_layout>
slsd_mode ::= Mode { Accelerate | Accumulate |
Supersample | Cave }
slsd_layout ::= Rows <nRows>

Columns <nCols>

slave_spec ::= <hostname> | <slave> | <master>
slave ::=

Slave

| | |
|---|---|
| Hostname | <hostname> |
| [ID | <id>] |

| | |
|---|---|
| [Device | <device_file>] |
| [Type | {2D \| 3D}] |
| [FastLanAddr | <ip_addr>] |

[FastLanType {Public | Private}]
[ServerOptions opt1 [val] ... optn [val]]
[ScreenOptions opt1 [val] ... optn [val]]
[Environment var1=val ... varn=val]

End

master ::=

Master

Hostname <hostname>

[ID <id>]

[Rows1 <rows>]

| | |
|---|---|
| [Cols | <cols>] |
| [Mode | <mode>] |

[SaveLayoutChanges {True | False} ]

[<hostname> | <id>]
[<hostname> | <id>]
...
[ServerOptions opt1 [val] ... optn [val]]
[ScreenOptions opt1 [val] ... optn [val]]
[Environment var1=val ... varn=val]

End

In the foregoing syntax, square brackets [ ] indicate an optional token or value and curved brackets { } indicate that one value from the choices listed between the brackets is required. Angle brackets < > refer to other items in the grammar that may be expanded. Non-stylized tems listed in angle brackets < > refer to what are expected to be obvious things (e.g., “hostname” would be a system's hostname without the domain suffix.

A special “token” may be used to indicate that a special syntax is being used. In the following example, the “SLSd” token indicates provides this indication.

```
[ServerOptions opt1 [val] ... optn [val]]
<slave_spec>
  <slave_spec>
  ...
SLSd
  [<hostname> | <id>]
  [<hostname> | <id>]
  ...
  [SlaveLayout <layout_options>]
  [SlaveServerOptions opt1 [val] ... optn [val]]
  [SlaveScreenOptions opt1 [val] ... optn [val]]
  [SlaveEnvironment var1=val ... varn=val]
  [DefaultVisual
    [Depth <n>]
    [Class
{PseudoColor|DirectColor|TrueColor|GrayScale}]
    [Layer {Image | Overlay}]
    [Transparent]
  [ScreenOptions opt1 [val] ... optn [val]]
```

Following the SLSd token is a list of slave specifications. The number of these specifications is dependent upon the slave layout. Finally, if an <slsd_layout> is specified, the Master will expect <nRows>*<nCols> slave specifications. SlaveServerOptions is optional and defines server options that may be applied to all slaves in the system (including master's also behaving as slaves). For example, if all slaves need to have the DLEs load immediately, this mechanism may be used to prevent having to re-type information in the individual <slave_spec>ServerOptions entries. This may be entered as: SlaveServerOptions ImmediateLoadDles. The syntax of this option indicates that each option may or may not have a value. Options may be added on additional lines if necessary. For example:

SlaveServerOptions ImmediateLoadDles
HpCursorScaleFactor 2

SlaveScreenOptions is optional and defines screen options that may be applied to all slaves in the system. The syntax of this option indicates that each option may or may not have a value. Options may be added on additional lines if necessary. For example:

SlaveScreenOptions EnableIncludeInferiorsFix
HpCursorPriorityBoost 2

SlaveEnvironment is optional and defines one or more environment variables that may be set in the environment of all slave X servers (to also be inherited by the OGL Daemon). The syntax of this option indicates that each variable has a value. Environment variables may be added on additional lines if necessary. For example:

SlaveEnvironment HPOGL_RENDER_FAST=1
HPOGL_DISPLAY_FRAMERRATE=1

DefaultVisual is optional and can be used to change the default visual for the entire SLS/d system. In previous installations of SLS/d, the default visual was selected by choosing the default visual of slave 0.

Depth is optional and specifies the default visual's depth. Typical values for <n> are 8 and 24.

Class is optional and specifies the default visual's visual class. One of the following values must be chosen: PseudoColor, DirectColor, TrueColor, or GrayScale.

Layer is optional and specifies whether the default visual shall live in the Overlays or in the Image Planes.

Transparent is optional and specifies that the default visual shall have a transparent entry in its default colormap.

ServerOptions is optional and defines server options that will only be visible to the Master. These screen options will not propagate to the slaves. If you want to use a big cursor, for example, this is where you would want to set the cursor scale variable (e.g., ServerOptions HpCursorScaleFactor 2).

ScreenOptions is optional and defines screen options that will only be visible to the Master. These screen options will not propagate to the slaves.

### SLS/d Slave Layout (<layout_options>)

A SlaveLayout token may be used for specifying the SLS/d Slave Layout. For example,

| slave_layout | ::= <slsd_mode> \| <slsd_layout> |
|---|---|
| slsd_mode | ::= Mode [ Accelerate \| Accumulate \| |
| Supersample \| Cave ] | |
| slsd_layout | ::= [ |

```
  Rows <nRows>
  Columns <nCols>
]
```

Therefore, to specify a non-Scalable 1×configuration, the user may enter:

```
SLSd
  host1 host2 host3
  SlaveLayout
    Rows 1
    Columns 3
```

To specify the Scalable Supersample Mode, the user may enter:

```
SLSd
  host1 host2 host3
  SlaveLayout
    Mode Supersample
```

<slsd_mode> and <slsd_layout> are mutually exclusive. If both are specified, then the specification that appears last in the X*screens file will be used. In some cases, an error may be generated if the parser becomes sufficiently confused.

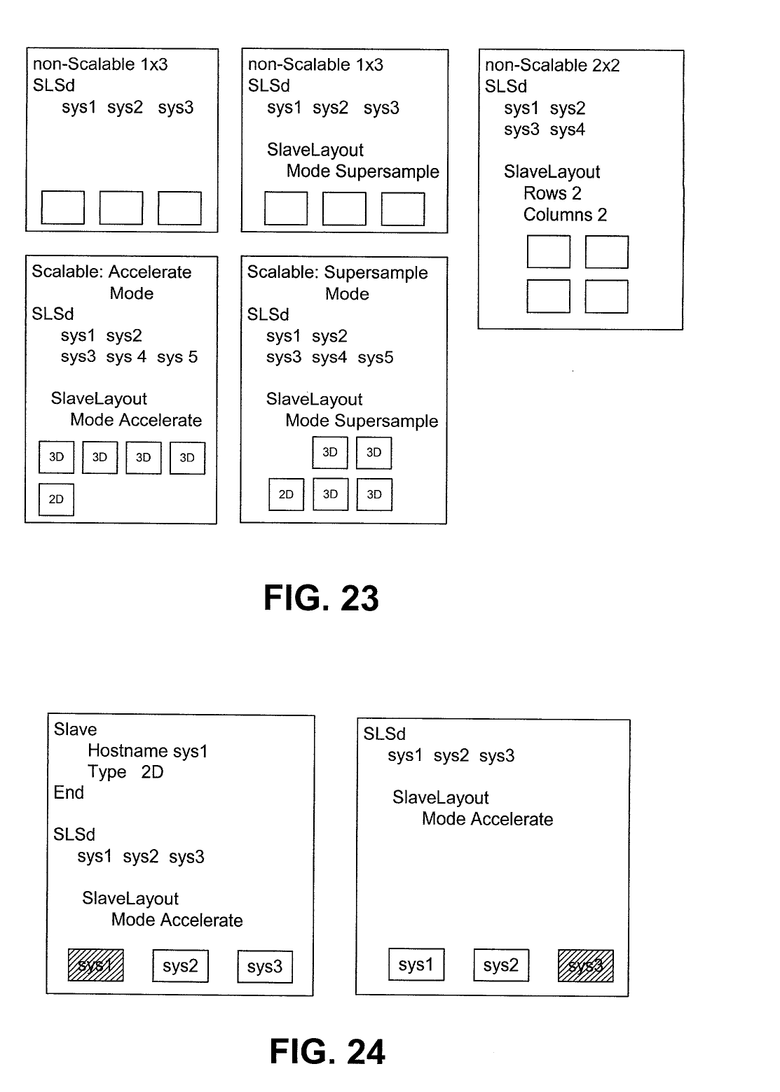

By way of illustration, FIG. 23 shows some possible configurations with their SLSd SlaveLayout lines. The Accelerate Mode example shows a 1×4 with a 2D slave (total of 5 Slaves). The Accelerate and Accumulate mode may be viewed as a plurality 1×1's. Supersample Mode is actually a 2×2 SLS/d configuration, with an additional 2D Slave. Thus, in FIG. 23, the Supersample Mode example is shown as a 2×2 and the Accelerate Mode example is shown as a 1×4.

<slave_spec>Specification

slave_spec::=<hostname>|<slave>|<master>

A slave specification can be either a <hostname>, a <slave>, or a <master>.

A <hostname> is name of a system without the domain suffix. A slave specified by a <hostname> may not define any slave-specific server options, may not define any slave-specific screen options, may not define any slave-specific environment, and may use /dev/crt for the graphics device.

A <slave> indicates that a single system will operate as the slave, but the system requires some non-default behavior. A <master> indicates that a set of systems may operate as a single slave.

| slave ::= | |
|---|---|
| Slave | |
| Hostname | <hostname> |
| [ID | <id>] |

| | |
|---|---|
| [Device | <device_file>] |
| [Type | {2D \| 3D}] |
| [FastLanAddr | <ip_addr>] |
| [FastLanType | {Public \| Private}] |

```
    [ServerOptions opt1 [val] ... optn [val]]
    [ScreenOptions opt1 [val] ... optn [val]]
    [Environment var1=val ... varn=val]
  End
```

The typical manifestation of a slave is a single-system slave. <slave> describes this case. All slave-specific options may be listed within the Slave . . . End tokens.

Hostname identifies the system name of the slave without the domain suffix.

ID is optional and is used if more than one slave is hosted on a single system. In other words, if two Slave . . . End definitions have the same host listed in Hostname, ID is required to uniquely identify the individual slaves. ID can be any value including digits and characters.

Device is optional and, if present, lists the path to the graphics device file. This is required if the target graphics device is not /dev/crt.

Type specifies whether or not the slave should be used for 2D or 3D rendering. Only one slave may be specified as the “2D” slave, or an error will result. The default value for this field is “3D”, therefore, only the 2D slave must be explicitly specified. FIG. 24 shows a couple of examples. The 2D slave is graphically displayed using the bold font and hash pattern.

FastLanAdidr is optional and is used only if a Gigabit (or other equally capable network connection) is connected to the Slave. The value is an IP address in the form of x.x.x.x (e.g., 192.168.1.1).

FastLanType is optional. Its value is either Public or Private indicating whether or not the FastLanAddr is connected to a public or private network. If this value is Public, the OpenGL daemon will not attempt to use Multicasting.

ServerOptions is optional. If present, the opt and opt val tokens describe X server ServerOptions that are specific to this slave.

ScreenOptions is optional. If present, the opt and opt val tokens describe X server ScreenOptions that are specific to this slave.

Environment is optional. If present, the var=val tokens list environment variables that will be set prior to starting the slave.

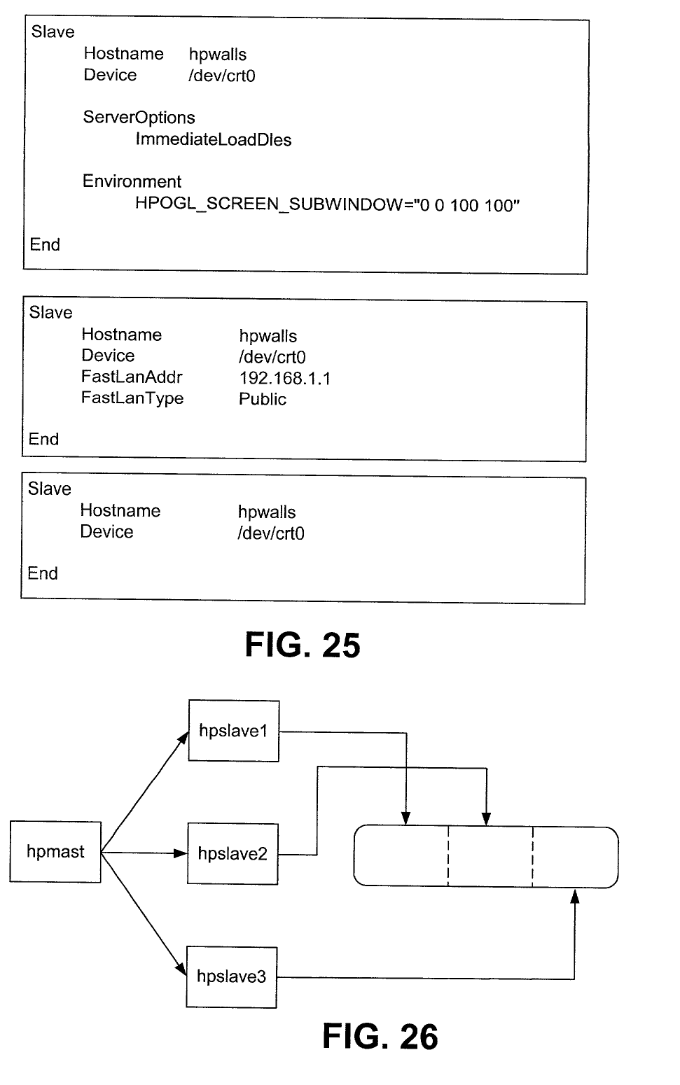

Reference is now made to FIG. 25, which shows a few examples of Slave Configurations.

### <master> Specification

| master ::= | |
|---|---|
| Master | |
| Hostname <hostname> | |
| [ID <Id>] | |
| [Rows <rows>] | |
| [Cols | <cols>] |
| [Mode | <mode>] |

```
  [SaveLayoutChanges {True | False} ]
    [<hostname> | <id>]
    [<hostname> | <id>]
    ...
    [ServerOptions opt1 [val] ... optn [val]]
    [ScreenOptions opt1 [val] ... optn [val]]
    [Environment var1=val ... varn=val]
  End
```

Another manifestation of a slave is a multi-system configuration operating as a single slave. <master> describes this case. All master-specific options must be listed within the Master . . . End tokens.

Hostname identifies the system name of the master system without the domain suffix.

ID is optional and is only used if more than one master or slave is hosted on a single system. In other words, if two Slave . . . End or Master . . . End definitions have the same host listed in Hostname, ID is required to uniquely identify the individual slaves. ID can be any value including digits and characters.

Rows/Cols may be required if the Master is going to support a complex SLS/d configuration that is not Sv6 related. In other words, if this is a true SLS/d (logical screen used for increased screen real-estate), then these values describe the underlying screen space layout. If this Master is defining components for a Sv6, then Rows and Cols may be omitted.

ServerOptions is optional. If present, the opt and opt val tokens describe X server ServerOptions that are specific to this master and will be propagated to all of the master's slaves.

ScreenOptions is optional. If present, the opt and opt val tokens describe X server ScreenOptions that are specific to this master and will be propagated to all of the master's slaves.

Environment is optional. If present, the var=val tokens list environment variables that will be set prior to starting the master and will be propagated to all of the master's slaves.

### Configuration Examples

To further illustrate various concepts of the invention, the following sets forth several examples.

### 1×3, non-Scalable, No Options

In this example, a 1×3 SLS/d configuration is established (see FIG. 26) using hpmast for the Master and hpslave1, hpslave2, and hpslave3 for the slaves. All slaves can use /dev/crt as their graphics devices and no other options are required.

```
hpmast:/etc/X11/X0screens
  SLSd
    hpslave1
    hpslave2
    hpslave3
    SlaveLayout
      Rows 1
      Columns 3
```

### 1×3, non-Scalable

In this example, a 1×3 SLS/d configuration is established using hpmast for the Master and hpslave1, hpslave2, and hpslave3 for the slaves. A big cursor is used, all DLEs must be loaded immediately on all slaves, set the default resolution to 1024×768, set the default visual to DirectColor 24, and the slaves will have the following requirements:

hpslave1 must use /dev/crt2 and must have the environment variable OGLD_RUN_FAST set to 3.

hpslave2 must have the screen option HpThisIsABogusOptionSoItDoesntConfusePaul set.

hpslave3 has no specific requirements. The configuration file may be as follows:

| hpmast:/etc/X11/X0screens | |
|---|---|
| ServerOptions | |
| HpCursorScaleFactor 2 | |
| Slave | |
| Hostname hpslave1 | |
| Device | /dev/crt2 |
| Environment | OGLD_RUN_FAST=3 |

| End | |
|---|---|
| Slave | |
| Hostname hpslave2 | |
| ScreenOptions | |
| HpThisIsABogusOptionSoItDoesntConfusePaul | |
| End | |
| SLSd | |
| hpslave1 | |
| hpslave2 | |
| hpslave3 | |
| SlaveLayout | |
| Rows 1 | |
| Columns 3 | |
| SlaveServerOptions ImmediateLoadDles | |
| SlaveMonitorConf | |
| Width | 1024 |
| Height | 768 |
| DefaultVisual | |
| Class | DirectColor |
| Depth | 24 |

### 2×2, non-Scalable, Use Private Fast Lan

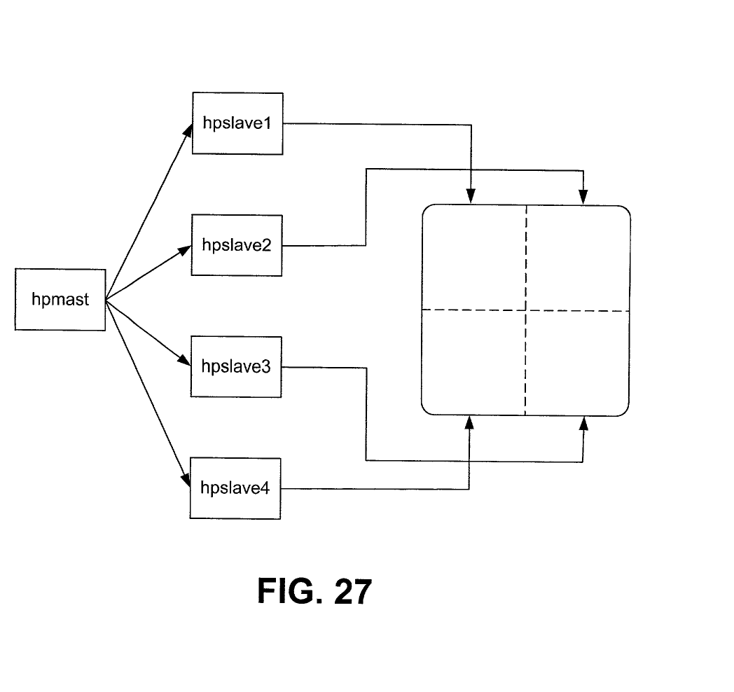

In this example, a 2×2 SLS/d configuration is established (See FIG. 27) using hpmast for the Master and hpslave1, hpslave2, hpslave3, and hpslave4 for the slaves. All slaves can use /dev/crt as their graphics devices and no other options are required. The configuration file may be as follows:

| hpmast:/etc/X11/X0screens | |
|---|---|
| Slave | |
| Hostname hpslave1 | |
| FastLanAddr | 192.1.0.1 |
| FastLanType | Private |
| End | |
| Slave | |
| Hostname hpslave2 | |
| FastLanAddr | 192.1.0.2 |
| FastLanType | Private |
| End | |
| Slave | |
| Hostname hpslave3 | |
| FastLanAddr | 192.1.0.3 |
| FastLanType | Private |
| End | |
| Slave | |
| Hostname hpslave4 | |
| FastLanAddr | 192.1.0.4 |
| FastLanType | Private |

```
End
SLSd
  hpslave1 hpslave2
  hpslave3 hpslave4
  SlaveLayout
    Rows 2
    Columns 2
```

### 1×3, Multiple Slaves on One Host

In this example, a 1×3 SLS/d configuration is established using hpmast for the Master and hpslave1 for all the slaves. hpslave1 has three graphics devices, /dev/crt0, /dev/crt1, and /dev/crt2. No other options are required. The configuration file may be as follows:

| hpmast:/etc/X11/X0screens | |
|---|---|
| Slave | |
| Hostname | hpslave1 |
| ID | hpslave1_0 |
| Device | /dev/crt0 |
| End | |
| Slave | |
| Hostname | hpslave1 |
| ID | hpslave1_1 |
| Device | /dev/crt1 |
| End | |
| Slave | |
| Hostname | hpslave1 |
| ID | hpslave1_2 |
| Device | /dev/crt2 |

```
End
SLSd
  hpslave1_0 hpslave1_1 hpslave1_2
  SlaveLayout
    Rows 1
    Columns 2
```

### 1×3 Three-Tiered Configuration

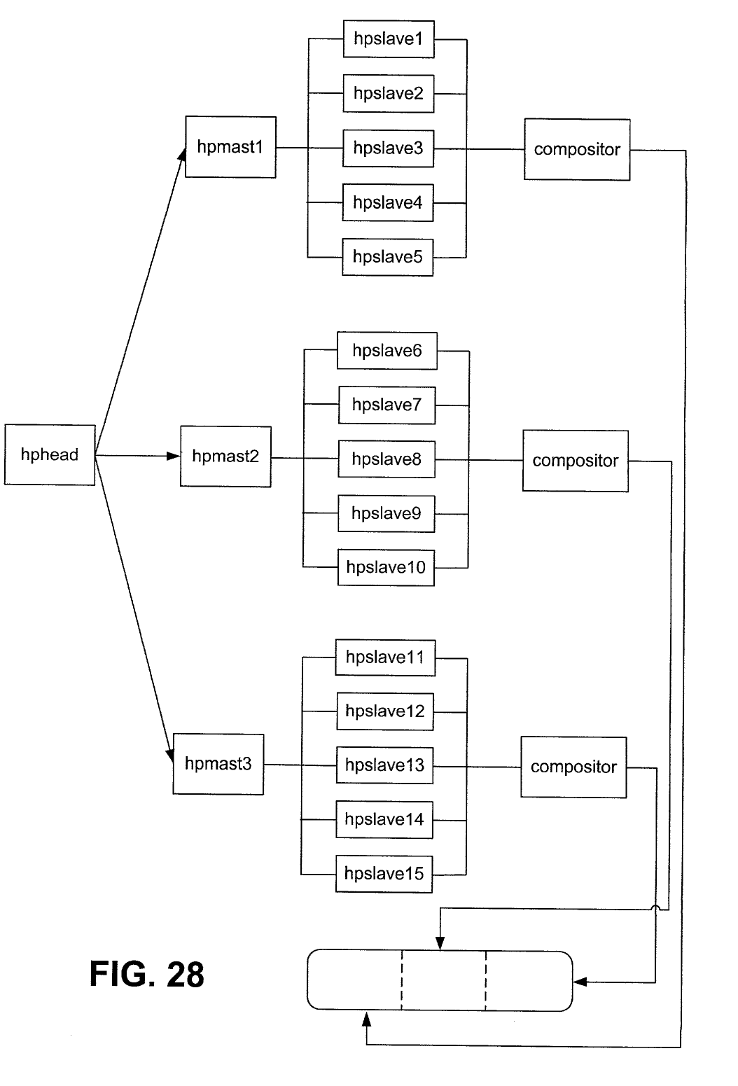

In this example (see FIG. 28), a 1×3 SLS/d, three-tiered (head, master, slave) configuration is established. hphead is the Head. The masters and slaves will be as follows:

| | | |
|---|---|---|
| hpmast1 | hpmast2 | hpmast3 |
| hpslave1 | hpslave6 | hpslave11 |
| hpslave2 | hpslave7 | hpslave12 |
| hpslave3 | hpslave8 | hpslave13 |
| hpslave4 | hpslave9 | hpslave14 |
| hpslave5 | hpslave10 | hpslave15 |

No special options are required. The configuration file may be as follows:

| hphead:/etc/X11/X0screens | |
|---|---|
| Master | |
| Hostname | hpmast1 |
| Mode | Accelerate |
| hpslave1 hpslave2 hpslave3 hpslave4 hpslave5 | |
| End | |
| Master | |
| Hostname | hpmast2 |
| Mode | Accelerate |
| hpslave6 hpslave7 hpslave8 hpslave9 hpslave10 | |
| End | |
| Master | |
| Hostname | hpmast3 |
| Mode | Accelerate |

```
  hpslave11 hpslave12 hpslave13 hpslave14 hpslave15
End
SLSd
  hpmast1 hpmast2 hpmast3
  SlaveLayout
    Rows 1
    Columns 3
  SlaveScreenOptions
  SlsMode Accelerate
    ScreenOptions
      SlsMode Accelerate
```

Now, therefore, the following is claimed:

1. A, method for configuring a plurality of networked slave computers to cooperate to collectively render a display comprising:
specifying, at a master computer, compatible operating configuration for each of the plurality of slave computers; and
communicating, across the network, the specified configuration to each of the plurality of slave computers.

2. The method of claim 1, wherein the step of communicating the specified configuration comprises communicating the specified configuration through a communication socket of each of the plurality of slave computers.

3. The method of claim 1, wherein the step of communicating the specified configuration comprises saving at least one slave configuration file in a predetermined location on each of the plurality of slave computers.

4. The method of claim 3, wherein the step of saving at least one configuration file comprises saving the at least one slave configuration file using a predetermined filename.

5. The method of claim 1, wherein the step of specifying, at a master computer, operating configurations further comprises the step of reading, by the master computer, a master configuration file that is stored in a predetermined location.

6. The method of claim 5, wherein the step of specifying, at a master computer, operating configurations further comprises the step of translating information from the master configuration file and saving the translated information into a plurality of slave configuration files.

7. The method of claim 5, wherein the step of specifying, at a master computer, operating configurations further comprises the step of translating information from the master configuration file and communicating the translated information to the plurality of slave computers.

8. A method for configuring a plurality of networked computer clusters to cooperate to collectively render a plurality of displays comprising:
specifying, at a head computer, configuration information for each of a plurality of master computers;
communicating, across the network, the specified configurations to each of the plurality of master computers;
specifying, at each master computer, compatible operating configuration for each of a plurality of slave computers; and
communicating, across the network, the configuration by each master computer to each of the plurality of slave computers of a computer cluster associated with a given master computer.

9. The method of claim 8, wherein the step of communicating the specified configuration comprises communicating the specified configuration through a communication socket of each of the plurality of slave computers.

10. The method of claim 8, wherein the step of communicating the specified configuration comprises saving at least one configuration file in a predetermined location on each of the plurality of slave computers.

11. The method of claim 10, wherein the step of saving at least one configuration file comprises saving the at least one configuration file using a predetermined filename.

12. The method of claim 8, wherein the step of specifying, at a head computer, operating configurations further comprises the step of reading, by the head computer, a head configuration file that is stored in a predetermined location.

13. The method of claim 12, wherein the step of specifying, at the head computer, operating configurations further comprises the step of translating information from the head configuration file and saving the translated information into a plurality of master configuration files.

14. The method of claim 12, wherein the step of specifying, at the head computer, operating configurations further comprises the step of translating information from the head configuration file and communicating the translated information to the plurality of master computers computers.

15. The method of claim 13, wherein the step of specifying, at each master computer, operating configurations further comprises the step of translating information from each master configuration file and saving the translated information into a plurality of slave configuration files.

16. The method of claim 14, wherein the step of specifying, at each master computer, operating configurations further comprises the step of further translating configuration information received at each master computer and communicating the further translated information to the plurality of slave.

17. A computer program for configuring a plurality of networked computers to cooperate to collectively render a display comprising:
a code segment configured to control the reception, at a master computer, of specified configurations for each of a plurality of slave computers;
a code segment configured to control the specification, at the master computer, compatible operating configuration for each of the plurality of slave computers; and
a code segment configured to control the communication of the specified configurations to each of the plurality of slave computers.

18. The computer program of claim 17, wherein the code segment configured to control the communication is configured to generate a slave configuration file containing configuration information.

19. The computer program of claim 17, wherein the code segment configured to control the communication is configured to communicate configuration information to each of the slave computers through a communication socket.
